(19) United States
(12) Patent Application Publication
(10) Pub. No.: US 2005/0099364 A1
(43) Pub. Date: May 12, 2005

(54) Energy recovery apparatus and method of a plasma display panel

(76) Inventors: Yun Kwon Jung, Gumi-si (KR); Joong Seo Park, Nam-gu (KR); Jin Young Kim, Dalseo-gu (KR); Sung Gon Shin, Habcheon-gun (KR); Won Tae Kim, Gumi-si (KR); Bong Koo Kang, Nam-gu (KR)

Correspondence Address: FLESHNER & KIM, LLP, P.O. BOX 221200, CHANTILLY, VA, 20153, US

(21) Appl. No.: 10/956,376

(22) Filed: Oct. 4, 2004

(30) Foreign Application Priority Data
Oct. 8, 2003 (KR) 10-2003-0069805
Dec. 4, 2003 (KR) 10-2003-0087705

(51) Int. Cl. G09G 3/28; G09G 5/00

(52) U.S. Cl. 345/60

(57) ABSTRACT

The present invention relates to a plasma display panel, and more particularly, to an energy recovery apparatus of a plasma display panel and method thereof. According to a first embodiment of the present invention, an energy recovery apparatus of a plasma display panel includes a resonance circuit making a sustain voltage resonate to generate a voltage increasing to a double voltage of the sustain voltage, a diode limiting the voltage generated from the resonance circuit not to exceed the sustain voltage, and a panel supplied with the sustain voltage from the resonance circuit under a control of the diode. Therefore, the present invention provides an energy recovery apparatus of a plasma display panel and method thereof, by which sustain discharge can occur stably without degrading efficiency and by which efficiency degradation and malfunction caused by noise due to a voltage variation can be prevented.

This Nonprovisional application claims priority under 35 U.S.C. § 119(a) on Patent Application No. 10-2003-0069805 filed in Korea on Oct. 8, 2003 and Patent Application No. 10-2003-0087705 filed in Korea on Dec. 4, 2003, the entire contents of which are hereby incorporated by reference.

### BACKGROUND OF THE INVENTION

1. Field of the Invention

The present invention relates to a plasma display panel, and more particularly, to an energy recovery apparatus and method of a plasma display panel.

2. Description of the Background Art

Generally, a plasma display panel (hereinafter abbreviated PDP) displays images in a manner of adjusting a gas discharge period of each pixel according to digital video data. As a representative one, there is a 3-electrodes AC surface discharge type PDP driven by AC voltage.

FIG. 1 is a perspective diagram of a discharge cell of a 3-electrodes AC surface discharge type PDP according to a related art.

Referring to FIG. 1, a discharge cell of a 3-electrodes AC surface discharge type PDP consists of a scan electrode 28Y and sustain electrode 29Z formed on an upper substrate 10 and an address electrode 20×formed on a lower substrate 18.

Each of the scan and sustain electrodes 28Y and 29Z has a line width smaller than that of a transparent electrode 12Y or 12Z and includes a metal bus electrode 13Y or 13Z provided to one side of the transparent electrode 12Y or 12Z. The transparent electrodes 12Y and 12Z are generally formed of indium tin oxide (ITO) on the upper substrate 10. The metal bus electrodes 13Y and 13Z are generally formed of metal such as Cr or the like on the transparent electrodes 12Y and 12Z to reduce the voltage drops caused by the transparent electrodes 12Y and 12Z of high resistance, respectively. An upper dielectric layer 14 and protecting layer 16 are stacked over the upper substrate 10 including the scan and sustain electrodes 28Y and 29Z. Wall charges generated from plasma discharge are accumulated on the upper dielectric layer 14. The protecting layer 16 protects the upper dielectric layer 14 against sputtering caused by plasma discharge and increases discharge efficiency of secondary electrons. And, the protecting layer 16 is generally formed of MgO.

The address electrode 20Z is formed in a direction crossing with that of the scan or sustain electrode 28Y or 29Z. A lower dielectric layer 22 and barrier rib 24 are formed on the lower substrate 8 having the address electrode 20×formed thereon. A fluorescent layer 26 is formed on surfaces of the lower dielectric layer 22 and the barrier rib 24. The barrier rib 24 is formed parallel to the address electrode 20Z to physically partition each discharge cell and prevents UV and visible rays generated from electric discharge from leaking to neighbor discharge cells. The fluorescent layer 26 is excited by the UV-ray generated from plasma discharge to emit light including one of red, green, and blue visible rays. A mixed inert gas such as He+Xe, Ne+Xe, He+Xe+Ne, and the like for electric discharge is injected in a discharge space of the discharge cell provided between the barrier ribs 24 and the upper and lower substrates 10 and 18.

A high voltage exceeding several hundreds volts is necessary for the address and sustain discharges of the AC surface discharge type PDP. Hence, in order to minimize the drive power necessary for the address or sustain discharge, an energy recovery device is used. The energy recovery device recovers the voltage applied to the discharge cell and then uses the recovered voltage as a drive voltage for next discharge.

FIG. 2 is a circuit diagram of an energy recovery device of PDP according to a related art.

Referring to FIG. 2, an energy recovery device 30 and 32 according to a related art is symmetrically provided centering around a panel capacitor Cp. The panel capacitor Cp equivalently represents capacitance formed between a scan electrode Y and a sustain electrode Z. The first energy recovery device 30 supplies a sustain pulse to the scan electrode Y. And, the second energy recovery device 32, which alternates to operate with the first energy recovery device 30, supplies a sustain pulse to the sustain electrode Z.

The configuration of the energy recovery device 30 and 32 of PDP according to the related art is explained by referring to the first energy recovery device 30 as follows. First of all, the first energy recovery device 30 consists of an inductor L connected between the panel capacitor Cp and a source capacitor Cs, first and third switches S1 and S3 connected parallel between the source capacitor Cs and the inductor L, and second and fourth switches S2 and S4 connected parallel between the panel capacitor Cp and the inductor L.

The second switch S2 is connected to a sustain voltage source Vs and the fourth switch S4 is connected to a ground voltage source GND. The source capacitor Cs recovers to be charged with a voltage of the panel capacitor Cp on sustain discharge and then re-supplies the recovered voltage to the panel capacitor Cp. In doing so, the source capacitor Cs becomes charged with a voltage of Vs/2 amounting to a half value of the sustain voltage source Vs. The inductor L and the panel capacitor Cp construct a resonance circuit. And, the first to fourth switches S1 to S4 control a current flow.

A fifth diode D5 provided between the first switch S1 and the inductor L or a sixth diode D6 provided between the third switch S3 and the inductor L is operative in preventing a current from flowing in reverse direction.

FIG. 3 is a timing and waveform diagram of on/off timings of switches and output waveforms of a panel capacitor in the first energy recovery device.

Assuming that the panel capacitor Cp and source capacitor Cs are charged with 0V and Vs/2 prior to a period T1, respectively, an operational process is explained in detail as follows.

During the period T1, the first switch S1 is turned on to form a current path from the source capacitor Cs to the panel capacitor Cp via the first switch S1 and the inductor L. Once the current path is formed, the charged voltage within the source capacitor Cs is supplied to the panel capacitor Cp. In doing so, since the inductor L and panel capacitor Cp construct a parallel circuit, the panel capacitor Cp is charged with a voltage of Vs.

During a period T2, the first switch S1 is turned off but the second switch S2 is turned on. Once the second switch S2 is turned on, the voltage of the sustain voltage source Vs is supplied to the scan electrode Y. The voltage of the sustain voltage source Vs supplied to the scan electrode Y prevents the voltage of the panel capacitor Cp from dropping below that of the sustain voltage source Vs, thereby enabling the sustain discharge to occur normally. Meanwhile, as the voltage of the panel capacitor Cp has been raised to Vs during the period T1, the drive power supplied from outside to trigger the sustain discharge can be minimized.

During a period T3, the turned-on state of the second switch S2 is maintained during a prescribed time. Hence, the voltage of the sustain voltage source Vs is supplied to the scan electrode Y during the period T3.

During a period T4, the second switch S2 is turned off but the third switch S3 is turned on. Once the third switch S3 is turned on, a current path from the panel capacitor Cp to the source capacitor Cs via the inductor L and the third switch S3 is formed so that the charged voltage within the panel capacitor Cp is recovered to the source capacitor Cs. In doing so, the source capacitor Cs becomes charged with the voltage of Vs/2.

During a period T5, the third switch S3 is turned off but the fourth switch S4 is turned on. Once the fourth switch S4 is turned on, a current path between the panel capacitor Cp and the ground voltage source GND is formed so that the voltage of the panel capacitor Cp drops to 0V. Meanwhile, during a period T6, the state of the period T5 is maintained for a prescribed period of time. Substantially, the AC drive pulses supplied to the scan and sustain electrodes Y and Z can be provided by repeating the periods T1 to T6 periodically.

Meanwhile, the second energy recovery device 32 alternates to operate with the first energy recovery device 30, thereby supplying the drive voltage to the panel capacitor Cp. Hence, the sustain pulse voltage Vs is alternately supplied to the panel capacitor Cp. Thus, as the sustain pulse voltage Vs is alternately supplied to the panel capacitor Cp, the sustain discharge occurs in the discharge cells.

Meanwhile, the related art energy recovery device supplies the voltage to the panel capacitor Cp using the LC resonance, whereby a waveform supplied to the panel capacitor Cp becomes a sine waveform during its rising and fall. Hence, a slope of the waveform supplied to the panel capacitor Cp, as shown in FIG. 4, decreases right before the rising curve arrives at the sustain voltage Vs. In other words, a slope of a pulse supplied from the energy recovery device 30 or 32 preferentially increases and then decreases right before the pulse arrives at the sustain voltage Vs. Thus, if the slope of the pulse supplied from the panel capacitor Cp decreases right before the pulse arrives at the sustain voltage Vs, weak sustain discharge occurs to provide insufficient brightness.

Moreover, if the pulse, of which slope decreases right before arriving at the sustain voltage Vs, is applied to the panel capacitor Cp, miswriting may occur in the panel capacitor Cp. Specifically, miswriting may occur if a small amount of charged particles is included within the panel capacitor Cp. Besides, in case that a large amount of priming charged particles is included within the panel capacitor Cp, sustain discharge may occur while the slope of the pulse gradually increases. In doing so, if the sustain discharge occurs during a period that the pulse increases to the sustain voltage Vs, i.e., during the period that the pulse increases by a small slope, i.e., if the discharge occurs before the sustain voltage Vs is supplied to the panel capacitor Cp, the sustain discharge may be erased since wall charges fail to be sufficiently formed.

In order to solve the above-described problem, a method of applying a drive waveform, as shown in FIG. 5, to the panel capacitor Cp is frequently used. Referring to FIG. 5, after a prescribed voltage has been supplied to the panel capacitor Cp, the second switch S2 is forcibly turned on before the voltage of the panel capacitor Cp reaches Vs, the voltage of the panel capacitor Cp is abruptly shifted to Vs so that the problem caused by the sine wave supply can be solved. Yet, if the second switch S2 is forcibly turned on, an additional voltage loss takes place to reduce efficiency.

### SUMMARY OF THE INVENTION

Accordingly, an object of the present invention is to solve at least the problems and disadvantages of the background art.

An object of the present invention is to provide an energy recovery apparatus of a plasma display panel and method thereof, by which sustain discharge can occur stably without degrading efficiency.

Another object of the invention is to provide an energy recovery apparatus of a plasma display panel and method thereof, by which efficiency degradation and malfunction caused by noise due to a voltage variation can be prevented.

According to a first embodiment of the present invention, an energy recovery apparatus of a plasma display panel includes a resonance circuit making a sustain voltage resonate to generate a voltage increasing to a double voltage of the sustain voltage, a diode limiting the voltage generated from the resonance circuit not to exceed the sustain voltage, and a panel supplied with the sustain voltage from the resonance circuit under a control of the diode.

According to a first embodiment of the present invention, an energy recovery method of a plasma display panel includes a first step of making a sustain voltage resonate to generate a voltage increasing to a double voltage of the sustain voltage and a second step of supplying the voltage generated from the first step to a panel capacitor equivalently provided to a discharge cell by controlling the voltage generated from the first step not to exceed the sustain voltage.

According to a second embodiment of the present invention, an energy recovery apparatus of a plasma display panel which supplies a positive first voltage and a negative second voltage to generate sustain discharge, includes a resonance circuit making the first voltage resonate to generate a voltage increasing to a double voltage of the first voltage, a diode limiting the voltage generated from the resonance circuit not to exceed the first voltage, and a panel supplied with the first voltage from the resonance circuit under a control of the diode to increase a voltage of the panel to the first voltage from the second voltage.

According to a second embodiment of the present invention, an energy recovery method of a plasma display panel which supplies a positive first voltage and a negative second voltage to generate sustain discharge, includes the steps of making the first voltage resonate to generate a voltage increasing to a double voltage of the first voltage, controlling the resonating voltage not to exceed the first voltage, and supplying the resonating voltage to a panel to increase a voltage of the panel to the first voltage from the second voltage.

According to a third embodiment of the present invention, an energy recovery apparatus of a plasma display panel includes a first path connected to a panel to supply a voltage higher than a sustain voltage, a second path connected to the first path to clip a voltage on the first path into the sustain voltage if the voltage on the first path reaches the sustain voltage, a third path discharging the sustain voltage supplied to the panel to a ground voltage source, a first cut-off element cutting off the voltage supplied to the panel via the first path from being supplied to the third path, and a second cut-off element cutting off the voltage discharged from the panel via the third path from being supplied to the first path.

According to a third embodiment of the present invention, an energy recovery method of a plasma display panel includes the steps of forming a first path connected to a panel to supply a voltage higher than a sustain voltage, clipping a voltage on the first path into the sustain voltage by forming a second path connected to the first path if the voltage on the first path reaches the sustain voltage, forming a third path discharging the sustain voltage supplied to the panel to a ground voltage source, cutting off the voltage supplied to the panel via the first path from being supplied to the third path, and cutting off the voltage discharged from the panel via the third path from being supplied to the first path.

According to a fourth embodiment of the present invention, an energy recovery apparatus of a plasma display panel includes a first path connected to a panel to supply a voltage higher than a sustain voltage, a second path connected to the first path to clip a voltage on the first path into the sustain voltage if the voltage on the first path reaches the sustain voltage, a third path storing the sustain voltage supplied to the panel in a first source capacitor, a first cut-off element cutting off the voltage supplied to the panel via the first path from being supplied to the third path, and a second cut-off element cutting off a voltage discharged from the panel via the third path from being supplied to the first path.

According to a fourth embodiment of the present invention, an energy recovery method for a plasma display panel includes the steps of forming a first path connected to a panel to supply a voltage higher than a sustain voltage, clipping a voltage on the first path into the sustain voltage by forming a second path connected to the first path if the voltage on the first path reaches the sustain voltage, forming a third path storing the sustain voltage supplied to the panel in a first source capacitor, cutting off the voltage supplied to the panel via the first path from being supplied to the third path, and cutting off a voltage discharged from the panel via the third path from being supplied to the first path.

Therefore, the present invention provides an energy recovery apparatus of a plasma display panel and method thereof, by which sustain discharge can occur stably without degrading efficiency and by which efficiency degradation and malfunction caused by noise due to a voltage variation can be prevented.

### BRIEF DESCRIPTION OF THE DRAWINGS

The invention will be described in detail with reference to the following drawings in which like numerals refer to like elements.

FIG. 1 is a perspective diagram of a discharge cell of a 3-electrodes AC surface discharge type PDP according to a related art.

FIG. 2 is a circuit diagram of an energy recovery device of PDP according to a related art.

FIG. 3 is a switching diagram of an operation of the energy recovery device in FIG. 2.

FIG. 4 is a diagram of a sustain pulse generated from the energy recovery device in FIG. 2.

FIG. 5 is a diagram of a sustain pulse generated from an energy recovery device according to another related art.

FIG. 6 is a circuit diagram of an energy recovery apparatus according to a first embodiment of the present invention.

FIG. 7 is a switching diagram of an operation of the energy recovery apparatus in FIG. 6.

FIG. 8 is a diagram of a sustain pulse generated from the energy recovery apparatus in FIG. 6.

FIG. 9 and FIG. 10 are circuit diagrams of explaining an operation of the energy recovery apparatus in FIG. 6.

FIG. 11 is a circuit diagram of an energy recovery apparatus according to a modification of the first embodiment of the present invention.

FIG. 12 is a switching diagram of an operation of the energy recovery apparatus in FIG. 11.

FIG. 13 is a circuit diagram of an operation of the energy recovery apparatus in FIG. 11.

FIG. 14 is a circuit diagram of an energy recovery apparatus according to a second embodiment of the present invention.

FIG. 15 is a diagram of a pulse supplied to a panel capacitor by the energy recovery apparatus in FIG. 14.

FIG. 16 is a circuit diagram of an energy recovery apparatus of a plasma display panel according to a third embodiment of the present invention.

FIG. 17 is a waveform diagram of a voltage variation on a second node according to a direction of a current flowing through an inductor shown in FIG. 16.

FIG. 18 is a waveform diagram of on/off timings of switches of the energy recovery apparatus of a plasma display panel shown in FIG. 16.

FIG. 19 is a circuit diagram representing on/off states of the switches and a current path during a period T1 shown in FIG. 18.

FIG. 20 is a waveform diagram of a sustain voltage supplied to a panel capacitor shown in FIG. 16.

FIG. 21 is a circuit diagram representing on/off states of the switches and a current path during a period T2 shown in FIG. 18.

FIG. 22 is a circuit diagram representing on/off states of the switches and a current path during a section-a of a period T3 shown in FIG. 18.

FIG. 23 is a circuit diagram representing on/off states of the switches and a current path during a section-b of a period T3 shown in FIG. 18.

FIG. 24 is a circuit diagram representing on/off states of the switches and a current path during a period T4 shown in FIG. 18.

FIG. 25 is a circuit diagram of an energy recovery apparatus of a plasma display panel according to a fourth embodiment of the present invention.

FIG. 26 is a waveform diagram of on/off timings of switches of the energy recovery apparatus of a plasma display panel in FIG. 25.

FIG. 27 is a circuit diagram representing on/off states of the switches and a current path during a period T1 shown in FIG. 26.

FIG. 28 is a circuit diagram representing on/off states of the switches and a current path during a period T2 shown in FIG; 26.

FIG. 29 is a circuit diagram representing on/off states of the switches and a current path during a period T3 shown in FIG. 26.

FIG. 30 is a circuit diagram representing on/off states of the switches and a current path during a period T4 shown in FIG. 26.

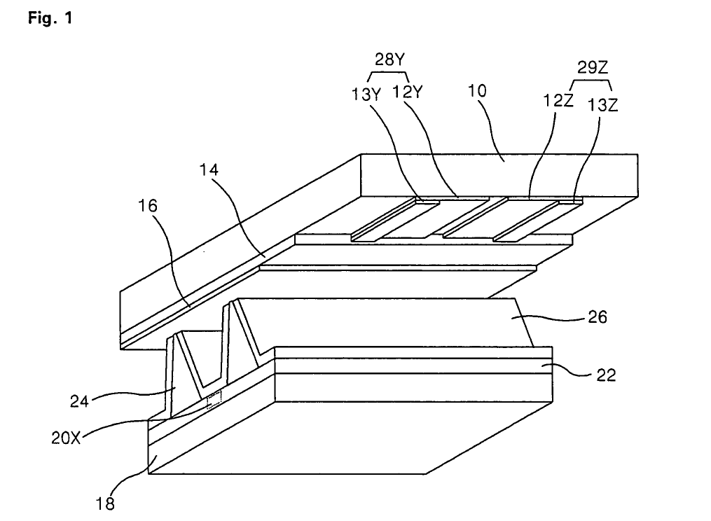

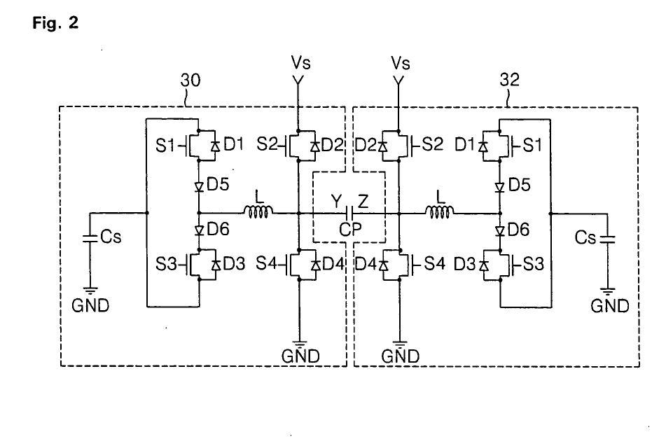

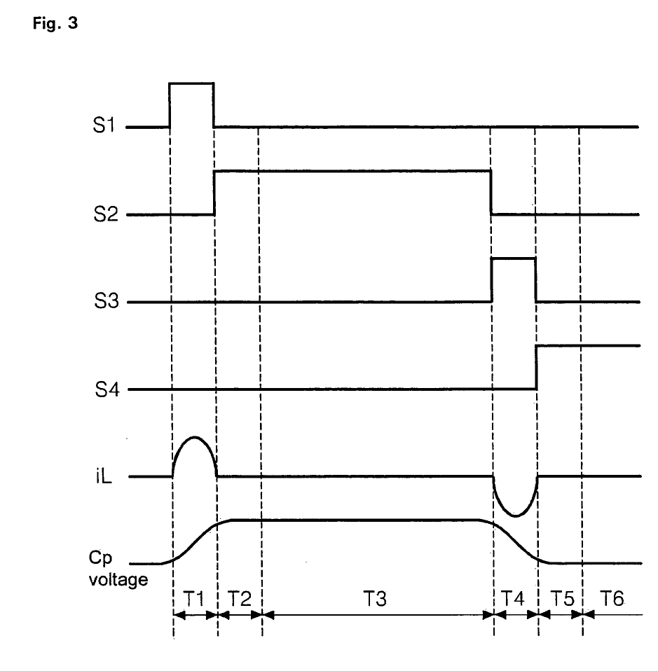

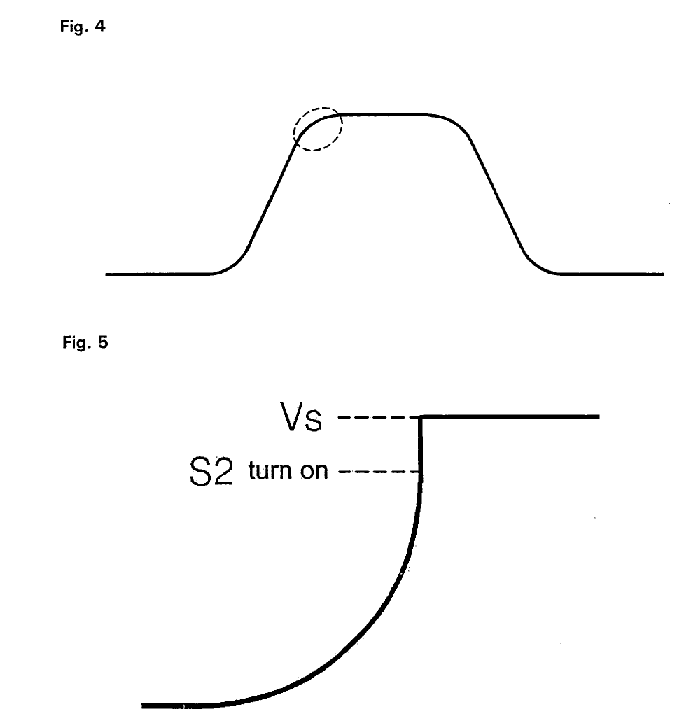

### DETAILED DESCRIPTION OF PREFERRED EMBODIMENTS

Preferred embodiments of the present invention will be described in a more detailed manner with reference to the drawings.

### First Embodiment

According to a first embodiment of the present invention, an energy recovery apparatus of a plasma display panel includes a resonance circuit making a sustain voltage resonate to generate a voltage increasing to a double voltage of the sustain voltage, a diode limiting the voltage generated from the resonance circuit not to exceed the sustain voltage, and a panel supplied with the sustain voltage from the resonance circuit under a control of the diode.

The energy recovery apparatus further includes a source capacitor connected to the resonance circuit to store the sustain voltage therein and a sustain voltage source connected parallel to the source capacitor.

The resonance circuit includes a panel capacitor equivalently provided to a discharge cell arranged like a matrix form on the panel and an inductor connected between the panel capacitor and the source capacitor.

The energy recovery apparatus further includes a first switch provided between the source capacitor and one side of the inductor to be turned on if the charged sustain voltage of the source capacitor is supplied to the inductor, a second switch provided between the source capacitor and the other side of the inductor to be turned on if the sustain voltage is supplied to the panel, a third switch provided between a ground voltage source and the one side of the inductor to be turned on if the voltage charged within the panel is discharged, and a fourth switch provided between the ground voltage source and the other side of the inductor to be turned on if a voltage of the ground voltage source is supplied to the panel.

The diode is an internal diode of the second switch.

If the first switch is turned on, the inductor is charged with energy. And, if the first switch is turned off, the charged energy of the inductor is supplied to the source capacitor via at least one of the diode and the second switch.

If the third switch is turned on, the voltage charged within the panel sinusoidally descends via the inductor to be supplied to the ground voltage source.

The energy charged within the inductor via the turned-on third switch is supplied to the source capacitor via an internal diode of the first switch after the third switch is turned off.

The energy recovery apparatus further includes a reference voltage source connected to the resonance circuit to have a voltage value corresponding to a half of the sustain voltage and a source capacitor provided between the reference voltage source and a ground voltage source to be charged with a voltage corresponding to the half of the sustain voltage.

The resonance circuit includes a panel capacitor equivalently provided to a discharge cell arranged like a matrix form on the panel and an inductor connected between the panel capacitor and a common terminal between the source capacitor and the reference voltage source.

The sustain voltage generated from adding the voltage value of the reference voltage source to the voltage of the source capacitor is supplied to the resonance circuit.

The energy recovery apparatus further includes a first switch provided between the reference voltage source and one side of the inductor to be turned on if the sustain voltage is supplied to the inductor, a second switch provided between the reference voltage source and the other side of the inductor to be turned on if the sustain voltage is supplied to the panel, a third switch provided between the source capacitor and the one side of the inductor to be turned on if the voltage charged within the panel is recovered to the source capacitor, and a fourth switch provided between the ground voltage source and the other side of the inductor to be turned on if a voltage of the ground voltage source is supplied to the panel.

The diode is an internal diode of the second switch.

If the third switch is turned on, the voltage charged within the panel sinusoidally descends via the inductor to be supplied to the source capacitor.

The energy recovery apparatus further includes a first diode provided between the first switch and the inductor to prevent a reverse current, a second diode provided between the second switch and the inductor to prevent the reverse current, a third diode provided between the ground voltage source and a common terminal of the first diode, the second diode, the inductor to maintain a voltage of the common terminal of the first diode, the second diode, and the inductor above the voltage of the ground voltage source, and a fourth diode provided between the common terminal of the first diode, the second diode, and the inductor and the reference voltage source to maintain the voltage of the common terminal of the first diode, the second diode, and the inductor below the sustain voltage.

According to a first embodiment of the present invention, an energy recovery method of a plasma display panel includes a first step of making a sustain voltage resonate to generate a voltage increasing to a double voltage of the sustain voltage and a second step of supplying the voltage generated from the first step to a panel capacitor equivalently provided to a discharge cell by controlling the voltage generated from the first step not to exceed the sustain voltage.

The energy recovery method further includes a third step of maintaining a voltage of the panel capacitor at the sustain voltage and a fourth step of discharging the voltage charged within the panel capacitor via an inductor so that the voltage charged within the panel capacitor can descend sinusoidally.

In the second step, the voltage generated in the first step is controlled not to exceed the sustain voltage using a diode provided between a resonance circuit generating a voltage increasing to a double voltage of the sustain voltage and a sustain voltage source.

Hereinafter, the first embodiment of the present invention will be described in detail with reference to the drawings.

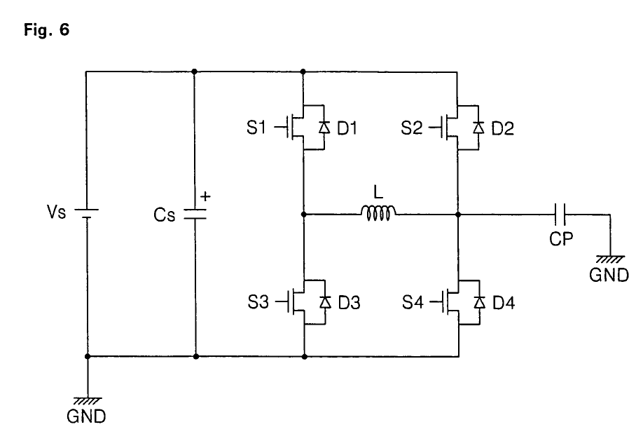

FIG. 6 is a circuit diagram of an energy recovery apparatus according to a first embodiment of the present invention, in which an energy recovery apparatus provided to one side of a panel capacitor Cp, e.g., next to a scan electrode Y, is shown. Substantially, a like energy recovery apparatus is provided to the other side of the panel capacitor Cp.

Referring to FIG. 6, an energy recovery apparatus according to a first embodiment of the present invention includes a sustain voltage source Vs, a source capacitor Cs connected parallel to the sustain voltage source Vs, a panel capacitor Cp equivalently provided to a discharge cell, an inductor L provided between the source capacitor Cs and the panel capacitor Cp, second and fourth switches S2 and S4 connected parallel between the inductor L and the panel capacitor Cp, and first and third switches S1 and S3 connected parallel between the inductor L and the source capacitor Cs.

The first and second switches S1 and S2 are connected to the sustain voltage source Vs, i.e., the source capacitor Cs, while the third and fourth switches S3 and S4 are connected to a ground voltage source GND. The source capacitor Cs is charged with a sustain voltage Vs. And, the inductor L constructs a resonance circuit together with the panel capacitor Cp. Each of the first to fourth switches S1 to S4 becomes turned on or off to supply the sustain voltage to the panel capacitor Cp. Internal diodes D1 to D4 are provided to the first to fourth switches S1 to S4, respectively to control a current flow.

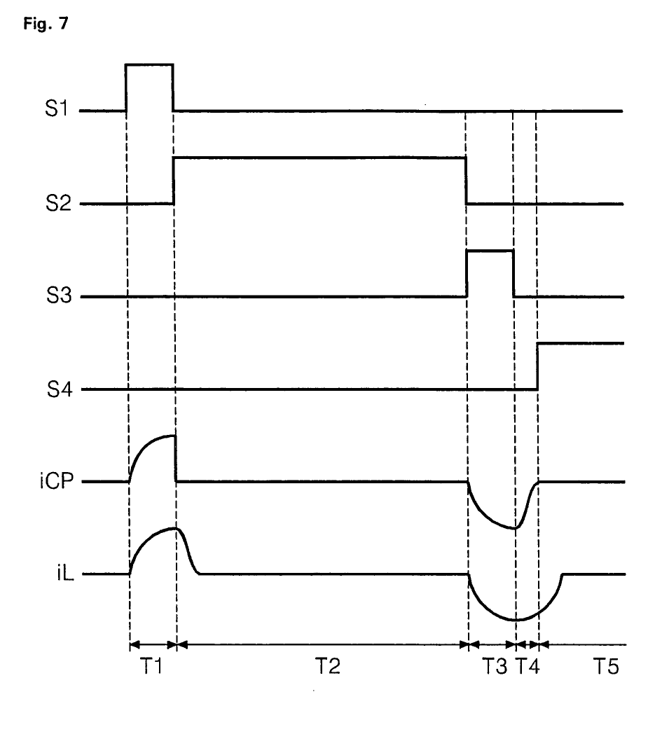

FIG. 7 is a switching diagram of an operation of the energy recovery apparatus in FIG. 6.

Assuming that the panel capacitor Cp and source capacitor Cs are charged with 0V and Vs prior to a period T1, respectively, an operational process is explained in detail as follows.

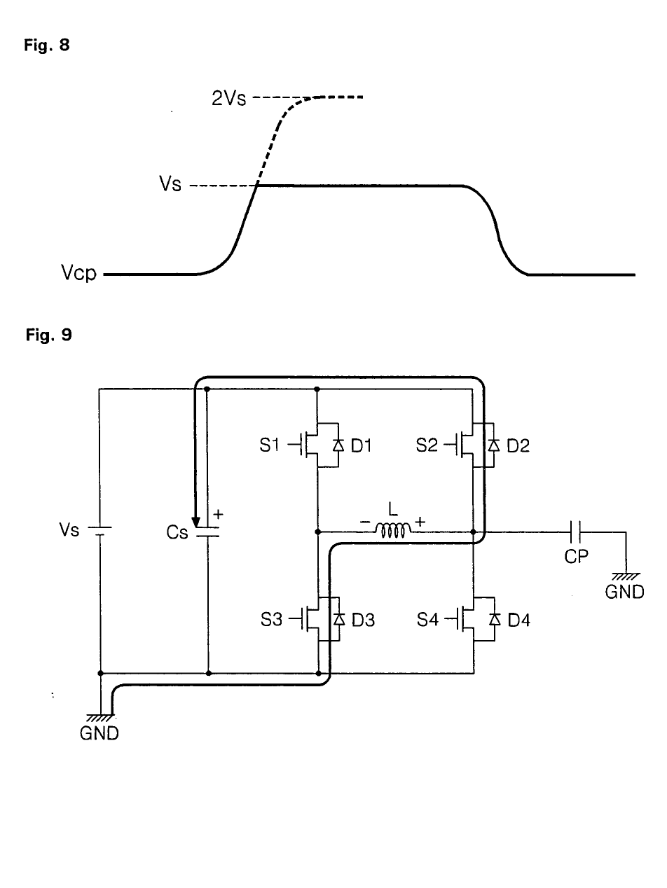

During the period T1, the first switch S1 is turned on. Once the first switch S1 is turned on, the charged sustain voltage Vs within the source capacitor Cs is passed through the first switch S1 and the inductor L to be supplied to the panel capacitor Cp. In doing so, the inductor L is charged with prescribed energy. In this case, the inductor L constructs a serial resonance circuit together with the panel capacitor Cp. Hence, the voltage applied to the panel capacitor Cp may be raised to a voltage of 2Vs as indicated by a dotted line in FIG. 8. Yet, the voltage substantially applied to the panel capacitor Cp is limited to the sustain voltage Vs by the internal diode D2 of the second switch S2. In this case, a turning-off timing point of the first switch S1 can be set to a time point that the panel capacitor Cp is charged with a specific voltage.

In other words, the voltage supplied to the panel capacitor Cp is controlled by the internal diode D2 of the second switch S2 not to exceed the sustain voltage Vs.

Meanwhile, the voltage supplied to the panel capacitor Cp during the period T1 is abruptly raised by resonance. Namely, the voltage applied to the panel capacitor Cp is raised at an abrupt slope by the resonance until reaching the sustain voltage Vs (i.e., the slope never decreases right before the voltage reaches the sustain voltage Vs). Hence, the present invention enables to bring about discharge stably.

During a period T2, the first switch S1 is turned off but the second switch S2 is turned on. When the second switch S2 is turned on, the voltage of the panel capacitor Cp is maintained at the sustain voltage Vs.

Meanwhile, if the first switch S1 is turned off, the polarity of the energy charged within the inductor L during the period T1 becomes reversed. In other words, if the first switch S1 is turned off, a reverse voltage, as shown in FIG. 9, is induced on the inductor L. The reverse voltage (reverse energy) induced on the inductor L is passed through the internal diode of the second switch S2 to be recovered to the source capacitor Cs.

During a period T3, the second switch S2 is turned off but the third switch S3 is turned on. Once the third switch S3 is turned on, the voltage charged within the panel capacitor Cp is supplied to the ground voltage source GND via the inductor L. In doing so, the inductor L is charged with prescribed energy. Since the voltage of the panel capacitor Cp is supplied to the ground voltage source GND via the inductor L, a potential of the panel capacitor Cp, as shown in FIG. 8, descends in the form of a sine wave. In other words, the potential of the panel capacitor Cp fails to descend abruptly during the period T3 but gradually descends in the form of a sine curve of which slope at a descending start or end point decreases. Thus, if the potential of the panel capacitor Cp descends like a since curve, EMI can be reduced.

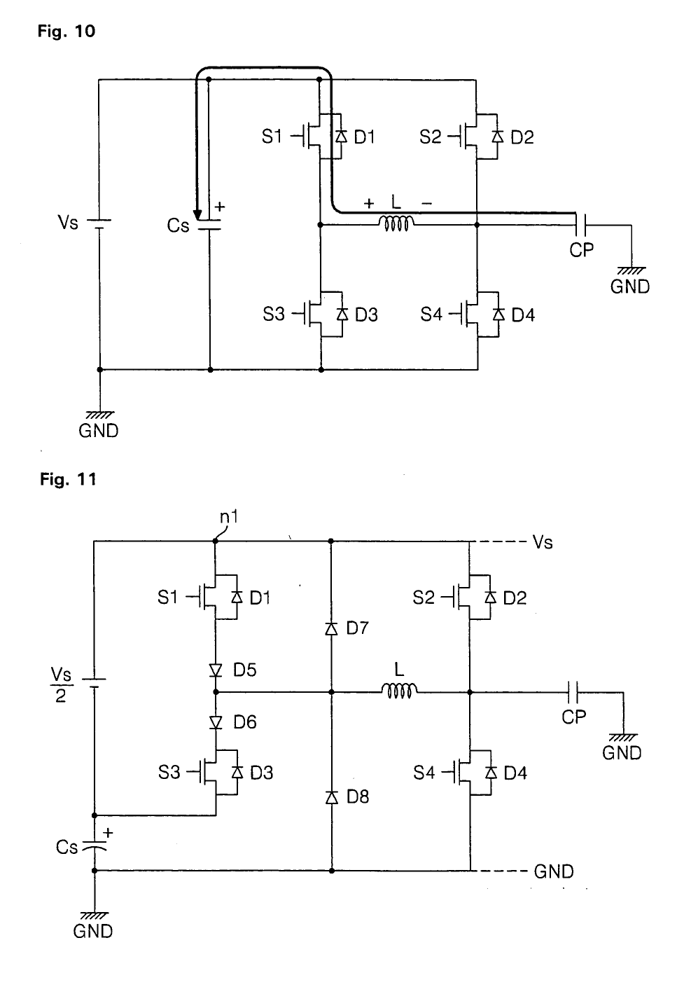

During a period T4, the third switch S3 is turned off. Namely, all of the first to fourth switches S1 to S4 keep being turned off during the period T4. If the third switch S3 is turned on, the polarity of the energy charged within the inductor L during the period T3 is reversed. In other words, once the third switch S3 is turned on, the reverse voltage, as shown in FIG. 10, is induced on the inductor L. The reversed energy induced on the inductor L is recovered to the source capacitor Cs via the internal diode D1 of the first switch S1.

During a period T5, the fourth switch S4 is turned on. If the fourth switch S4 is turned on, a ground voltage GND is supplied to the panel capacitor Cp. Namely, the panel capacitor Cp maintains the ground potential GND during the period T5. Substantially, the energy recovery apparatus according to the first embodiment of the present invention periodically repeats the periods T1 to T5 to supply the sustain pulses to the panel capacitor Cp.

FIG. 11 is a circuit diagram of an energy recovery apparatus according to a modification of the first embodiment of the present invention. In FIG. 11, an energy recovery apparatus provided to one side of a panel capacitor Cp, e.g., next to a scan electrode Y, is shown. Substantially, a like energy recovery apparatus is provided to the other side of the panel capacitor Cp.

Referring to FIG. 11, an energy recovery apparatus according to a modification of the first embodiment of the present invention includes a panel capacitor Cp equivalently provided to a discharge cell, a reference voltage source Vs/2 having a voltage amounting to a half of sustain voltage Vs, a source capacitor Cs provided between the reference voltage source Vs/2 and a ground voltage source GND, an inductor L provided between a common terminal between the source capacitor Cs and the reference voltage source Vs/2 and the panel capacitor Cp, first and third switches S1 and S3 connected parallel between the inductor L and the reference voltage source Vs/2, and second and fourth switches S2 and S4 connected parallel between the panel capacitor Cp and the inductor L.

The first and second switches S1 and S2 are connected to the reference voltage source Vs/2, and the fourth switch S4 is connected to the ground voltage source GND. And, the third switch S3 is connected to the common terminal of the reference voltage source Vs/2 and the source capacitor Cs. The source capacitor Cs recovers to be charged with the voltage charged within the panel capacitor Cp on sustain discharge and then re-supplies the charged voltage to the panel capacitor Cp. In doing so, the source capacitor Cs is charged with the voltage of Vs/2 amounting to a half value of the sustain voltage source Vs. The inductor constructs a resonance circuit together with the panel capacitor Cp. Each of the first to fourth switches S1 to S4 is turned on or off so that the sustain voltage Vs can be supplied to the panel capacitor Cp. Moreover, internal diodes D1 to D4 are provided to the first to fourth switches S1 to S4, respectively to control a current flow.

Meanwhile, the sustain voltage Vs is substantially supplied to the first and second switches S1 and S2 connected to the reference voltage source Vs/2. In other words, a total voltage Vs of the voltage Vs/2 charged within the source capacitor Cs and the reference voltage source Vs/2 is applied to a first node n1. Namely, in the modification of the first embodiment of the present invention, the sustain voltage VS is generated using the voltage of the reference voltage source Vs/2 corresponding to a half of the sustain voltage Vs, whereby power consumption can be reduced.

Meanwhile, the energy recovery apparatus according to the modification of the first embodiment of the present invention further includes a fifth diode D5 provided between the inductor L and the first switch S1, a sixth diode D6 provided between the inductor L and the third switch S3, a seventh diode D7 provided between the first node n1 and a common terminal between the inductor L and the fifth diode D5, and an eighth diode D8 provided between a common terminal between the inductor L and the sixth diode D6 and the ground voltage source GND.

The fifth and sixth diodes D5 and D6 prevent a reverse current from flowing. The seventh diode D7 prevents the voltage between the inductor L and the fifth diode D5 from exceeding the sustain voltage Vs. And, the eighth diode D8 prevents the voltage between the inductor L and the sixth diode D6 from decreasing below the ground potential GND.

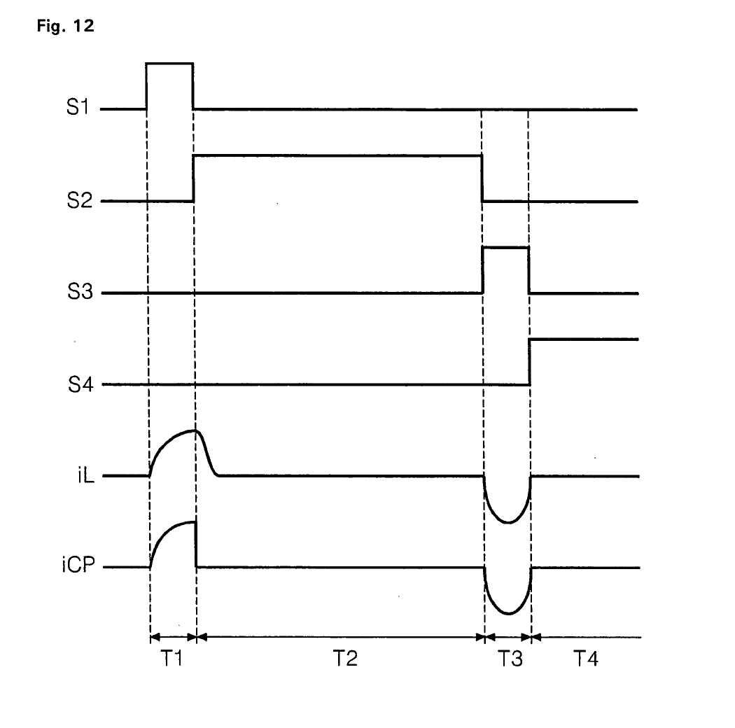

FIG. 12 is a switching diagram of an operation of the energy recovery apparatus in FIG. 11. Assuming that the panel capacitor Cp and source capacitor Cs are charged with 0V and Vs/2 prior to a period T1, respectively, an operational process is explained in detail as follows.

During the period T1, the first switch S1 is turned on. Once the first switch S1 is turned on, the sustain voltage Vs, i.e., (Vs/2+Cs voltage), applied to the first node n1 is passed through the first switch S1, fifth diode D5, and inductor L to be supplied to the panel capacitor Cp. In doing so, the inductor L is charged with prescribed energy. In this case, the inductor L constructs a serial resonance circuit together with the panel capacitor Cp. Hence, the voltage applied to the panel capacitor Cp may be raised to a voltage of 2Vs as indicated by a dotted line in FIG. 8. Yet, the voltage substantially applied to the panel capacitor Cp is limited to the sustain voltage Vs by the internal diode D2 of the second switch S2. In other words, the voltage supplied to the panel capacitor Cp is controlled by the internal diode D2 of the second switch S2 not to exceed the sustain voltage Vs.

Meanwhile, the voltage supplied to the panel capacitor Cp during the period T1 is abruptly raised by resonance. Namely, the voltage applied to the panel capacitor Cp is raised at an abrupt slope by the resonance until reaching the sustain voltage Vs (i.e., the slope never decreases right before the voltage reaches the sustain voltage Vs). Hence, the present invention enables to bring about discharge stably.

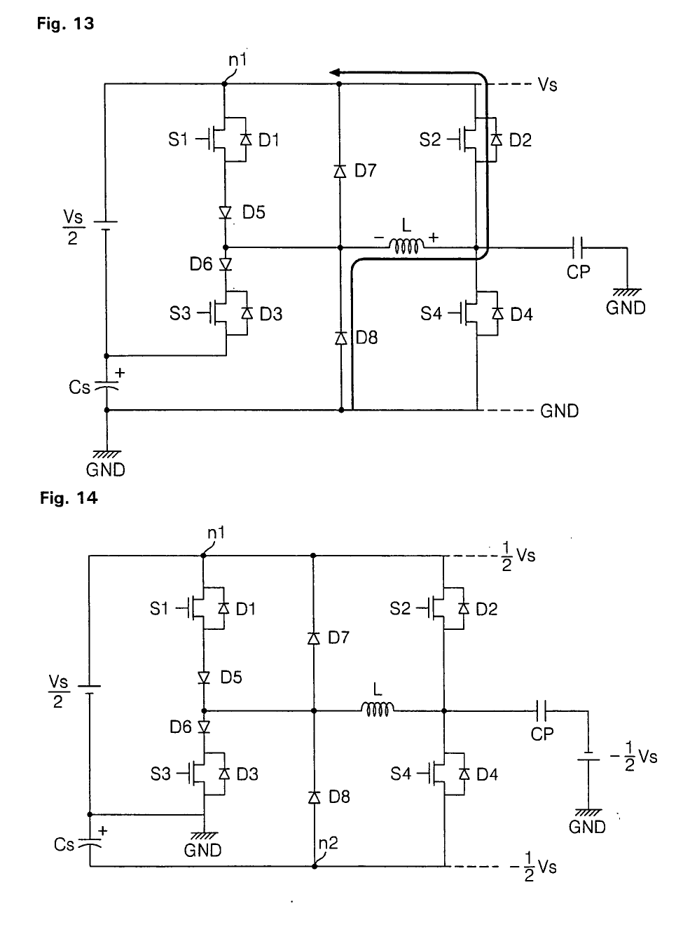

During a period T2, the first switch S1 is turned off but the second switch S2 is turned on. When the second switch S2 is turned on, the voltage of the panel capacitor Cp is maintained at the sustain voltage Vs. Meanwhile, if the first switch S1 is turned off, the polarity of the energy charged within the inductor L during the period T1 becomes reversed. In other words, if the first switch S1 is turned off, a reverse voltage, as shown in FIG. 13, is induced on the inductor L. The reverse voltage (reverse energy) induced on the inductor L is passed through the internal diode of the second switch S2 to be supplied to the reference voltage source Vs/2.

During a period T3, the second switch S2 is turned off but the third switch S3 is turned on. Once the third switch S3 is turned on, the voltage charged within the panel capacitor Cp is supplied to the source capacitor Cs via the inductor L. Meanwhile, since the voltage of the panel capacitor Cp is supplied to the source capacitor Cs via the inductor L, a potential of the panel capacitor Cp, as shown in FIG. 8, descends in the form of a sine wave. In other words, the potential of the panel capacitor Cp fails to descend abruptly during the period T3 but gradually descends in the form of a sine curve of which slope at a descending start or end point decreases. Thus, if the potential of the panel capacitor Cp descends like a since curve, EMI can be reduced.

During a period T4, the third switch S3 is turned off but the fourth switch is turned on. If the fourth switch S4 is turned on, the ground voltage GND is supplied to the panel capacitor Cp. Namely, the panel capacitor Cp maintains the ground potential GND during the period T4. Substantially, the energy recovery apparatus according to the modification of the first embodiment of the present invention periodically repeats the periods T1 to T4 to supply the sustain pulses to the panel capacitor Cp.

### Second Embodiment

According to a second embodiment of the present invention, an energy recovery apparatus of a plasma display panel which supplies a positive first voltage and a negative second voltage to generate sustain discharge, includes a resonance circuit making the first voltage resonate to generate a voltage increasing to a double voltage of the first voltage, a diode limiting the voltage generated from the resonance circuit not to exceed the first voltage, and a panel supplied with the first voltage from the resonance circuit under a control of the diode to increase a voltage of the panel to the first voltage from the second voltage.

The energy recovery apparatus further includes a reference voltage source having a negative terminal connected to a ground voltage source to supply the first voltage to the resonance circuit and a source capacitor having a positive terminal connected to the negative terminal of the reference voltage source to generate the second voltage by recovering to be charged with the first voltage charged within the panel.

The first and second voltages are set equal to each other in an absolute voltage value.

The resonance circuit includes a panel capacitor equivalently provided to a discharge cell arranged like a matrix form on the panel and an inductor connected between the panel capacitor and the reference voltage source.

The energy recovery apparatus further includes a first switch provided between the reference voltage source and one side of the inductor to be turned on if the first voltage is supplied to the inductor, a second switch provided between the reference voltage source and the other side of the inductor to be turned on if the first voltage is supplied to the panel, a third switch provided between the positive terminal of the source capacitor and the one side of the inductor to be turned on if the voltage charged within the panel is supplied to the source capacitor, and a fourth switch provided between the negative terminal of the source capacitor and the other side of the inductor to be turned on if the second voltage is supplied to the panel.

The diode is an internal diode of the second switch.

If the third switch is turned on, the voltage charged within the panel sinusoidally descends via the inductor to be supplied to the source capacitor.

The energy recovery apparatus further includes a first diode provided between the first switch and the inductor to prevent a reverse current, a second diode provided between the second switch and the inductor to prevent the reverse current, a third diode provided between a common terminal of the first switch and the first diode and the negative terminal of the source capacitor to prevent a voltage of the common terminal of the first switch and the first diode from decreasing below the second voltage, and a fourth diode provided between a common terminal of the inductor and the first diode and the reference voltage source to prevent a voltage of the common terminal of the inductor and the first diode from increasing above the first voltage.

According to a second embodiment of the present invention, an energy recovery method of a plasma display panel which supplies a positive first voltage and a negative second voltage to generate sustain discharge, includes the steps of making the first voltage resonate to generate a voltage increasing to a double voltage of the first voltage, controlling the resonating voltage not to exceed the first voltage, and supplying the resonating voltage to a panel to increase a voltage of the panel to the first voltage from the second voltage.

The energy recovery method further includes the steps of maintaining the first voltage after the voltage of the panel is increased to the first voltage and decreasing the voltage of the panel to the second voltage via an inductor to enable the voltage of the panel decrease sinusoidally.

The first and second voltages are set equal to each other in an absolute voltage value.

Hereinafter, the second embodiment of the present invention will be described in detail with reference to the drawings.

FIG. 14 is a circuit diagram of an energy recovery apparatus according to a second embodiment of the present invention. An operational process of an energy recovery apparatus according to a second embodiment of the present invention is identical to that according to the modification of the first embodiment of the present invention. Yet, ½ sustain voltage Vs/2 or (−)½ sustain voltage (−)Vs/2 is supplied to a panel capacitor Cp in a second embodiment of the present invention, whereas the sustain voltage VS or ground potential GND is supplied to the panel capacitor Cp in the modification of the first embodiment of the present invention. (Namely, the absolute value of the voltage supplied in the second or third embodiment of the present invention is identical.)

Referring to FIG. 14, an energy recovery apparatus according to a second embodiment of the present invention includes a panel capacitor Cp equivalently provided to a discharge cell, a reference voltage source Vs/2 having a voltage amounting to a half of sustain voltage Vs, an inductor L connected between the reference voltage source Vs/2 and the panel capacitor Cp, first and third switches S1 and S3 connected parallel between the inductor L and the reference voltage source Vs/2, second and fourth switches S2 and S4 connected parallel between the inductor L and the panel capacitor Cp, and a source capacitor Cs provided between the fourth switch S4 and a negative terminal of the reference voltage source Vs/2.

The first and second switches S1 and S2 are connected to the reference voltage source Vs/2, and the third switch S3 is connected to a ground voltage source GND. And, the negative terminal of the reference voltage source Vs/2 and a positive terminal of the source capacitor Cs are connected to the ground voltage source GND. Thus, if the negative terminal of the reference voltage source Vs/2 and the positive terminal of the source capacitor Cs are connected to the ground voltage source GND, a first node n1 has a potential of ½Vs and a second nod n2 has a potential of (−)½Vs. And, the fourth switch S4 is connected to the second node n2, i.e., a negative terminal of the source capacitor Cs.

The source capacitor Cs is charged with the voltage of Vs/2 amounting to a half value of the sustain voltage Vs. The inductor constructs a resonance circuit together with the panel capacitor Cp. Each of the first to fourth switches S1 to S4 is turned on or off so that the voltage of the panel capacitor Cp can vary to (−)½Vs or ½Vs. Moreover, internal diodes D1 to D4 are provided to the first to fourth switches S1 to S4, respectively to control a current flow.

Meanwhile, the energy recovery apparatus according to the second embodiment of the present invention further includes a fifth diode D5 provided between the inductor L and the first switch S1, a sixth diode D6 provided between the inductor L and the third switch S3, a seventh diode D7 provided between the first node n1 and a common terminal between the inductor L and the fifth diode D5, and an eighth diode D8 provided between a common terminal between the inductor L and the sixth diode D6 and the ground voltage source GND.

The fifth and sixth diodes D5 and D6 prevent a reverse current from flowing. The seventh diode D7 prevents the voltage between the inductor L and the fifth diode D5 from exceeding the sustain voltage Vs. And, the eighth diode D8 prevents the voltage between the inductor L and the sixth diode D6 from decreasing below the ground potential GND.

An operational process of the energy recovery apparatus according to the second embodiment of the present invention is explained with reference to FIG. 12.

Assuming that the panel capacitor Cp is charged with the voltage of (−1)½Vs prior to a period T1, the operational process is explained in detail as follows. Substantially, the other side of the panel capacitor Cp is connected to a potential of ½Vs.

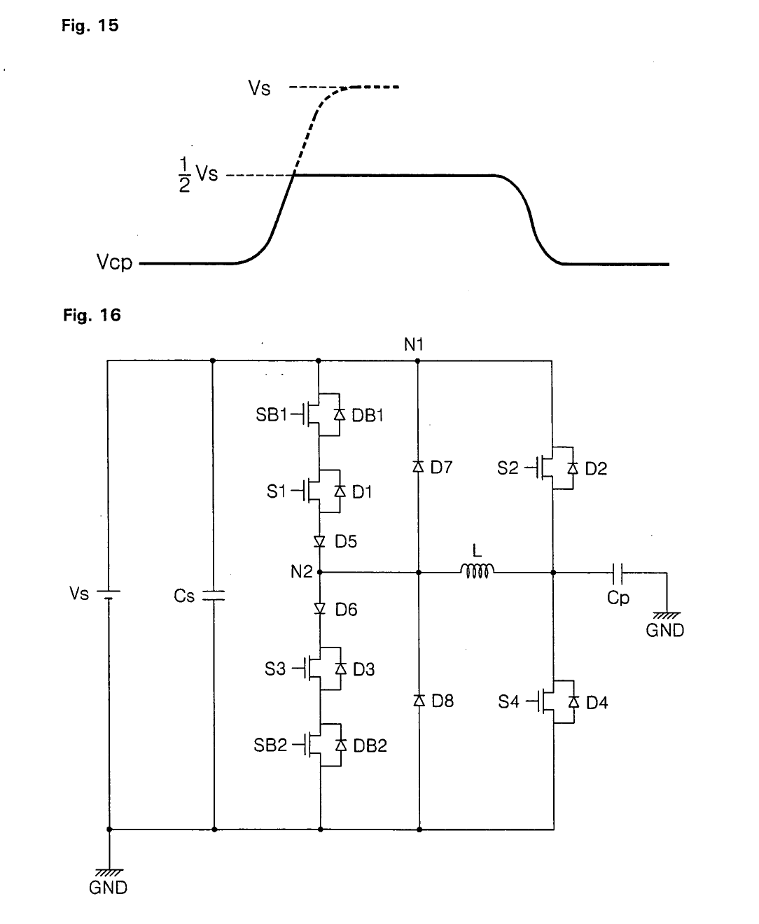

During the period T1, the first switch S1 is turned on. Once the first switch S1 is turned on, the voltage of ½Vs applied to the first node n1 is passed through the first switch S1, fifth diode D5, and inductor L to be supplied to the panel capacitor Cp. In doing so, the inductor L is charged with prescribed energy. In this case, the inductor L constructs a serial resonance circuit together with the panel capacitor Cp. Hence, the voltage applied to the panel capacitor Cp may be raised to a voltage of Vs as indicated by a dotted line in FIG. 15. Yet, the voltage substantially applied to the panel capacitor Cp is limited to the voltage of ½Vs by the internal diode D2 of the second switch S2. In other words, the voltage supplied to the panel capacitor Cp is controlled by the internal diode D2 of the second switch S2 not to exceed ½Vs.

Meanwhile, the voltage supplied to the panel capacitor Cp during the period T1 is abruptly raised by resonance. Namely, the voltage applied to the panel capacitor Cp is raised at an abrupt slope by the resonance until reaching the voltage of ½Vs (i.e., the slope never decreases right before the voltage reaches the voltage of ½Vs). Hence, the present invention enables to bring about sustain discharge stably.

During a period T2, the first switch S1 is turned off but the second switch S2 is turned on. When the second switch S2 is turned on, the voltage of the panel capacitor Cp is maintained at the voltage of ½Vs. Meanwhile, if the first switch S1 is turned off, the polarity of the energy charged within the inductor L during the period T1 becomes reversed. The reverse energy induced on the inductor L is passed through the second switch S2 and/or the internal diode D2 to be supplied to the reference voltage source Vs/2.

During a period T3, the second switch S2 is turned off but the third switch S3 is turned on. Once the third switch S3 is turned on, the voltage charged within the panel capacitor Cp is supplied to the source capacitor Cs via the inductor L. Meanwhile, since the voltage of the panel capacitor Cp is supplied to the source capacitor Cs via the inductor L, a potential of the panel capacitor Cp, as shown in FIG. 15, descends in the form of a sine wave. In other words, the potential of the panel capacitor Cp fails to descend abruptly during the period T3 but gradually descends in the form of a sine curve of which slope at a descending start or end point decreases. Thus, if the potential of the panel capacitor Cp descends like a since curve, EMI can be reduced.

During a period T4, the third switch S3 is turned off but the fourth switch is turned on. If the fourth switch S4 is turned on, the voltage of the second node n2, i.e., (−)Vs/2 is supplied to the panel capacitor Cp. Namely, the panel capacitor Cp maintains the potential of (−)Vs/2 during the period T4. Substantially, the energy recovery apparatus according to the second embodiment of the present invention periodically repeats the periods T1 to T4 to supply the voltage to the panel capacitor Cp.

As mentioned in the foregoing description of the energy recovery apparatus and method thereof according to the first or second embodiment of the present invention, in order to bring about the stable sustain discharge, the resonance circuit is configured to enable to generate the voltage higher than that to be supplied to the panel capacitor and a specific one of the generated voltage is controlled to be supplied to the panel capacitor only. In other words, since the voltage supplied to the panel capacitor increases with an abrupt slope, the sustain discharge can take place stably regardless of the amount of charged particles included within the panel capacitor. And, the voltage charged within the panel capacitor is discharged via the inductor so that the voltage of the panel capacitor decreases in the form of the sine wave, whereby EMI can be minimized.

### Third Embodiment

According to a third embodiment of the present invention, an energy recovery apparatus of a plasma display panel includes a first path connected to a panel to supply a voltage higher than a sustain voltage, a second path connected to the first path to clip a voltage on the first path into the sustain voltage if the voltage on the first path reaches the sustain voltage, a third path discharging the sustain voltage supplied to the panel to a ground voltage source, a first cut-off element cutting off the voltage supplied to the panel via the first path from being supplied to the third path, and a second cut-off element cutting off the voltage discharged from the panel via the third path from being supplied to the first path.

The energy recovery apparatus further includes a panel capacitor equivalently provided to a discharge cell arranged like a matrix form on the panel, a sustain voltage source generating the sustain voltage, and a source capacitor supplied with the sustain voltage from the sustain voltage source and storing the voltage supplied via the second path.

The first path includes a first node connected to the source capacitor, an inductor connected between the first node and the panel capacitor, and a first switch connected between the first node and the inductor to form a path between the source capacitor and the inductor.

The second path includes a second switch connected between the first node and a node between the inductor and the panel capacitor and a first diode connected between a second node between the inductor and the first switch and the ground voltage source.

The first diode prevents a voltage on the second node from decreasing below a ground voltage.

The second switch includes a second diode clipping a voltage on the first path into the sustain voltage.

The third path includes a third switch connected between the second node and the ground voltage source.

The first cut-off element is a first auxiliary switch connected between the first switch and the first node.

The second cut-off element is a second auxiliary switch connected between the third switch and the ground voltage source.

The energy recovery apparatus further includes a fourth path supplying a ground voltage from the ground voltage source to the panel.

The fourth path includes a fourth switch connected between a node between the panel capacitor and the inductor and the ground voltage source.

The energy recovery apparatus further includes a third diode preventing a reverse current between the first switch and the second node, a fourth diode preventing the reverse current between the second node and the third switch, and a fifth diode connected between the second node and the first node to prevent a voltage on the second node from increasing above the sustain voltage.

According to a third embodiment of the present invention, an energy recovery method of a plasma display panel includes the steps of forming a first path connected to a panel to supply a voltage higher than a sustain voltage, clipping a voltage on the first path into the sustain voltage by forming a second path connected to the first path if the voltage on the first path reaches the sustain voltage, forming a third path discharging the sustain voltage supplied to the panel to a ground voltage source, cutting off the voltage supplied to the panel via the first path from being supplied to the third path, and cutting off the voltage discharged from the panel via the third path from being supplied to the first path.

The energy recovery method further includes a step of maintaining a voltage of a panel capacitor at the sustain voltage wherein the panel capacitor is equivalently provided to a discharge cell arranged like a matrix form on the panel.

In the clipping step, the voltage on the first path is maintained at the sustain voltage in a manner of storing the voltage on the first path in a source capacitor using a diode connected between an inductor on the first path and a panel capacitor when the voltage on the first path reaches the sustain voltage.

In the step of forming the third step, the voltage charged within the panel capacitor is discharged to the ground voltage source via the inductor to decrease the voltage charged within the panel capacitor sinusoidally.

Hereinafter, the third embodiment of the present invention will be described in detail with reference to the drawings.

FIG. 16 is a circuit diagram of an energy recovery apparatus of a plasma display panel according to a third embodiment of the present invention. In FIG. 16, an energy recovery apparatus provided to one side of a panel capacitor Cp, e.g., next to a scan electrode Y, is shown. Substantially, a like energy recovery apparatus is provided to the other side of the panel capacitor Cp.

Referring to FIG. 16, an energy recovery apparatus according to a third embodiment of the present invention includes a sustain voltage source Vs, a source capacitor Cs connected parallel to the sustain voltage source Vs, a panel capacitor Cp equivalently provided to a discharge cell, an inductor L provided between the source capacitor Cs and the panel capacitor Cp, first and third switches S1 and S3 connected parallel between the inductor L and the source capacitor Cs, and second and fourth switches S2 and S4 connected parallel between the inductor L and the panel capacitor Cp.

The first and second switches S1 and S2 are connected to the sustain voltage source Vs, i.e., the source capacitor Cs, while the third and fourth switches S3 and S4 are connected to a ground voltage source GND. The source capacitor Cs is charged with a sustain voltage Vs. And, the inductor L constructs a resonance circuit together with the panel capacitor Cp. Each of the first to fourth switches S1 to S4 becomes turned on or off to form a current path so that the sustain voltage Vs can be supplied to the panel capacitor Cp. Internal diodes D1 to D4 are provided to the first to fourth switches S1 to S4, respectively to control a current flow.

Meanwhile, the energy recover apparatus for a plasma display panel according to the third embodiment of the present invention further includes a first auxiliary switch SB1 provided between the first switch S1 and the source capacitor Cs, a second auxiliary switch SB2 provided between the third switch S3 and the ground voltage source GND, a fifth diode D5 provided between the inductor L and the first switch S1, a sixth diode D6 provided between the inductor L and the third switch S3, a seventh diode D7 provided between a first node N1 connected to the sustain voltage source Vs and a second node N2 connected to a first terminal of the inductor L and the fifth and sixth diodes D5 and D6, and an eighth diode D8 provided between the second node N2 and the ground voltage source GND.

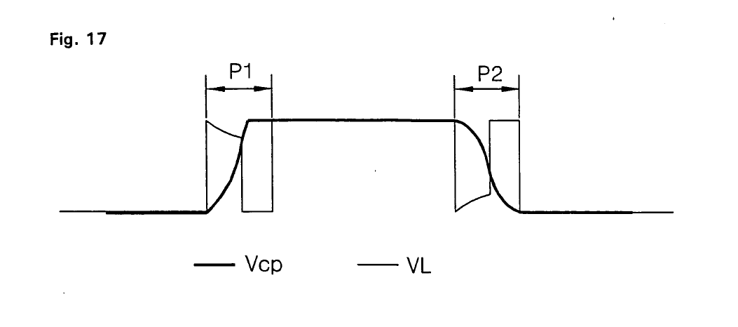

During a slope-increasing section P1 and slope-decreasing section P2 of the sustain voltage Vs supplied to the panel capacitor Cp, as shown in FIG. 17, an abrupt flow of the current flowing through the inductor L increases a variance (dv/dt) of a voltage VL at the second node N2 connected to the first terminal of the inductor L, thereby bringing about noise. By the noise, the first or third switch S1 or S3 is instantly shorted at an unwanted time point. Yet, the first and second auxiliary switches SB1 and SB2 enable to prevent the voltage losses caused by the instant short-circuit of the first and third switches S1 and S3 at the unwanted time points, respectively.

Specifically, the first switch S1 becomes instantly shorted by the noise. In this case, the noise is induced in a manner that a voltage Vgs between gate and source terminals increases via a parasitic capacitor Cgs between the gate and source terminals when the variance (dv/dt) of the voltage supplied to the second node N2 becomes negative (−) by the current flow of the inductor L. Hence, the first auxiliary switch SB1 prevents the voltage, which is supplied via the first switch S1 shorted at the unwanted time point, from being supplied to the first node N1.

Likewise, the third switch S3 becomes instantly shorted by the noise. In this case, the noise is induced in a manner that a voltage Vgs between gate and source terminals increases via a parasitic capacitor Cgd between the gate and source terminals when the variance (dv/dt) of the voltage supplied to the second node N2 becomes positive (+) by the current flow of the inductor L. Hence, the second auxiliary switch SB2 prevents the voltage, which is supplied via the third switch S3 shorted at the unwanted time point, from being supplied to the ground voltage source GND.

Thus, the first and second auxiliary switches SB1 and SB2 enable to prevent the voltage losses caused by the instant short-circuit, which is triggered by the noise due to the variance (dv/dt) of the voltage supplied to the second node N2 according to the direction of the current flowing through the inductor L, of the first and third switches S1 and S3 at the unwanted time points, respectively.

The fifth and sixth diodes D5 and D6 prevent a reverse current from flowing. The seventh diode D7 prevents the voltage between the inductor L and the fifth diode D5, i.e., the voltage at the second node N2, from exceeding the sustain voltage Vs. And, the eighth diode D8 prevents the voltage between the inductor L and the sixth diode D6, i.e., the voltage at the second node N2, from decreasing below the ground potential GND.

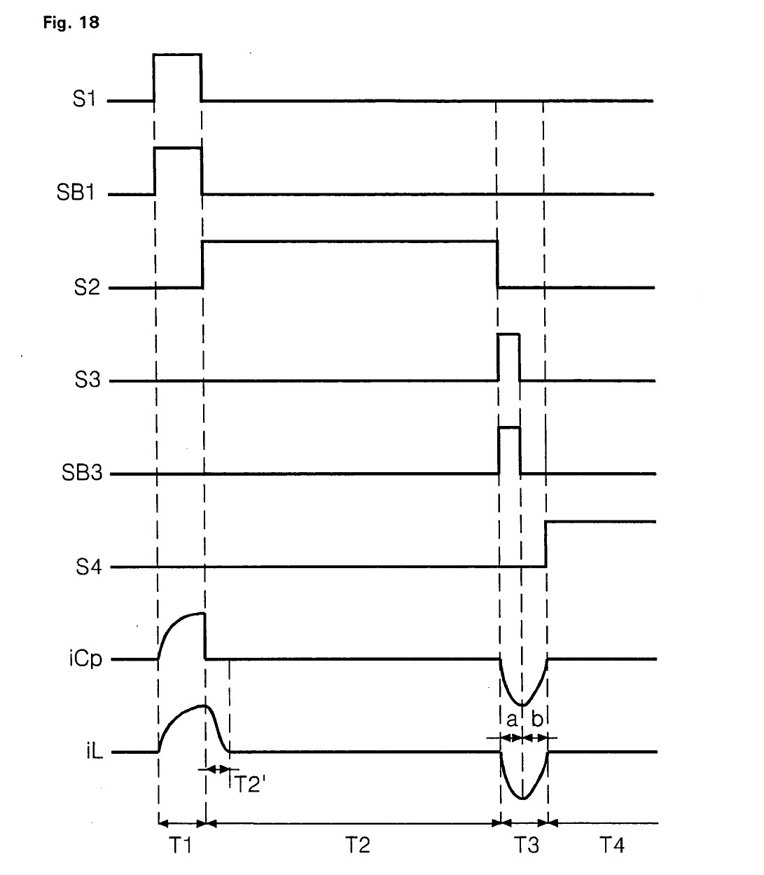

FIG. 18 is a waveform diagram of on/off timings of switches of the energy recovery apparatus of a plasma display panel shown in FIG. 16.

By combining FIG. 18 and FIG. 16, an energy recovery apparatus of a plasma display panel and method thereof according to a third embodiment of the present invention are explained in the following. First of all, assuming that the panel capacitor Cp and source capacitor Cs are charged with 0V and Vs prior to a period T1, respectively, an operational process is explained in detail as follows.

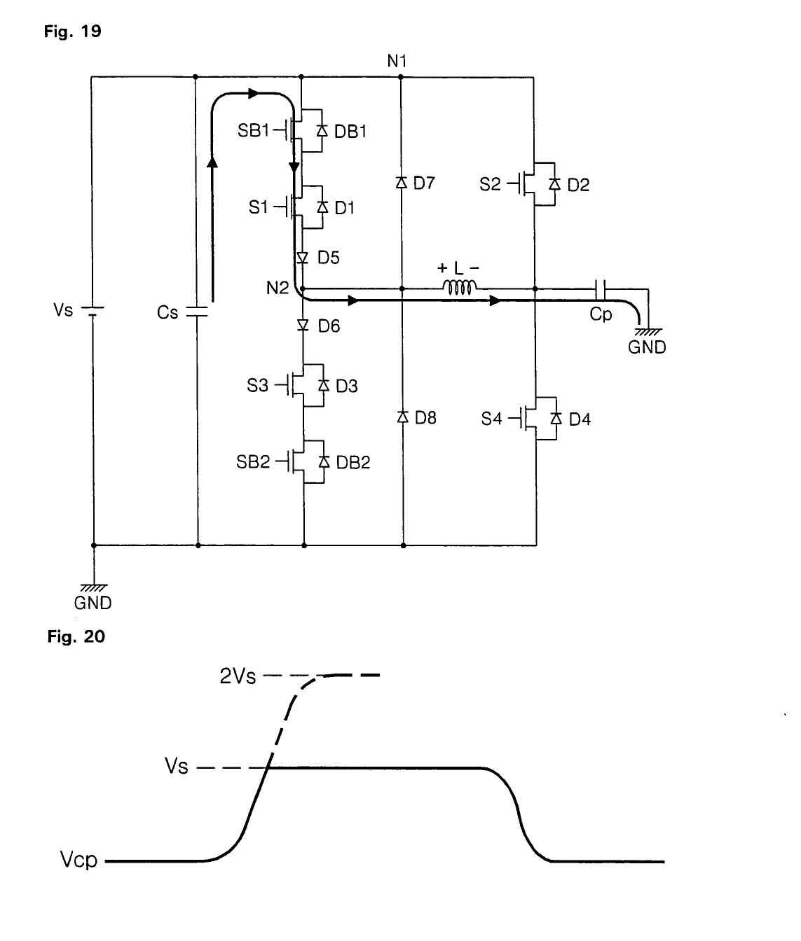

During the period T1, the first switch S1 and first auxiliary switch SB1 are turned on. Once the first switch S1 and auxiliary switch SB1 are turned on, the sustain voltage Vs charged within the source capacitor, as shown in FIG. 19, is passed through the first auxiliary switch SB1, first switch S1, and inductor L to be supplied to the panel capacitor Cp. In doing so, the inductor L is charged with prescribed energy. In this case, the inductor L constructs a serial resonance circuit together with the panel capacitor Cp. Hence, the voltage applied to the panel capacitor Cp can be raised to a voltage of 2Vs as indicated by a dotted line in FIG. 20. Yet, the voltage substantially applied to the panel capacitor Cp is limited to the sustain voltage Vs by the internal diode D2 of the second switch S2. (In this case, a time point of turning off the first switch S1 and the first auxiliary switch SB1 can be set to a time point that the panel capacitor Cp is charged with a specific voltage.) In other words, the voltage supplied to the panel capacitor Cp is clipped by the internal diode D2 of the second switch S2 not to exceed the sustain voltage Vs.

And, the third switch S3 becomes instantly shorted by the noise. In this case, the noise is induced in a manner that a voltage Vgs between gate and source terminals increases via a parasitic capacitor Cgd between the gate and source terminals when the variance (dv/dt) of the voltage supplied to the second node N2 becomes positive (+) by the current flowing through the inductor L during the period T1. Hence, the second auxiliary switch SB2 prevents the voltage, which is supplied via the third switch S3 shorted at the unwanted time point, from being supplied to the ground voltage source GND, thereby enabling to prevent the loss of the voltage supplied to the panel capacitor Cp from the source capacitor Cs.

Accordingly, the voltage supplied to the panel capacitor Cp during the period T1 is abruptly raised by resonance with an abrupt slope until reaching the sustain voltage Vs (i.e., the slope never decreases right before the voltage reaches the sustain voltage Vs). Hence, the present invention enables to bring about sustain discharge stably.

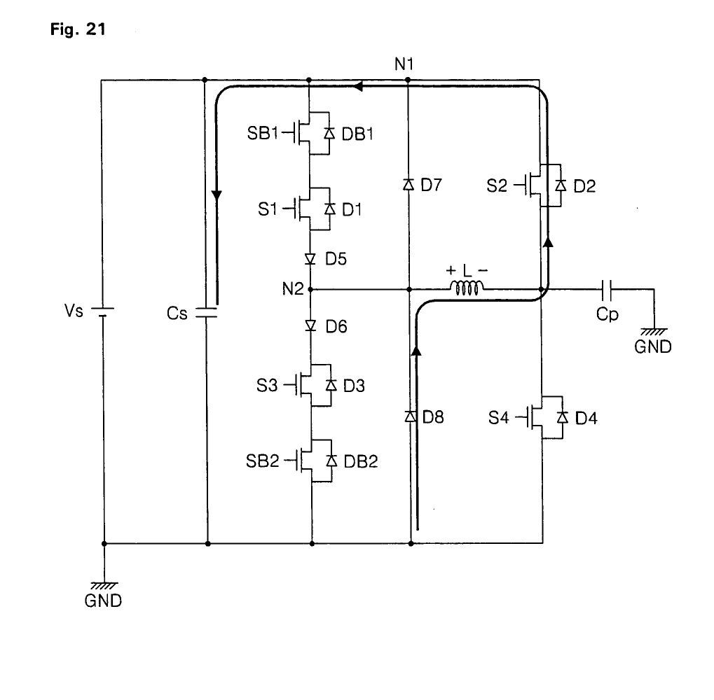

During a period T2, the first switch S1 and the first auxiliary switch SB1 are turned off but the second switch S2 is turned on. When the second switch S2 is turned on, the voltage of the panel capacitor Cp is maintained at the sustain voltage Vs. Meanwhile, if the first switch S1 and the first auxiliary switch SB1 are turned off, the polarity of the energy charged within the inductor L during the period T1 becomes reversed. In other words, if the first switch S1 and the first auxiliary switch SB1 are turned off, a reverse voltage, as shown in FIG. 21, is induced on the inductor L so that the voltage at the second node N2 abruptly decreases to the negative voltage (−) or ground potential GND during a period T2 shown in FIG. 18 to turn on an electric current through the eighth diode D8. Hence, the reverse voltage (reverse energy) induced on the inductor L is passed through the eighth diode D8, the inductor L, and the internal diode D2 of the second switch S2 to be recovered to the source capacitor Cs via current path.

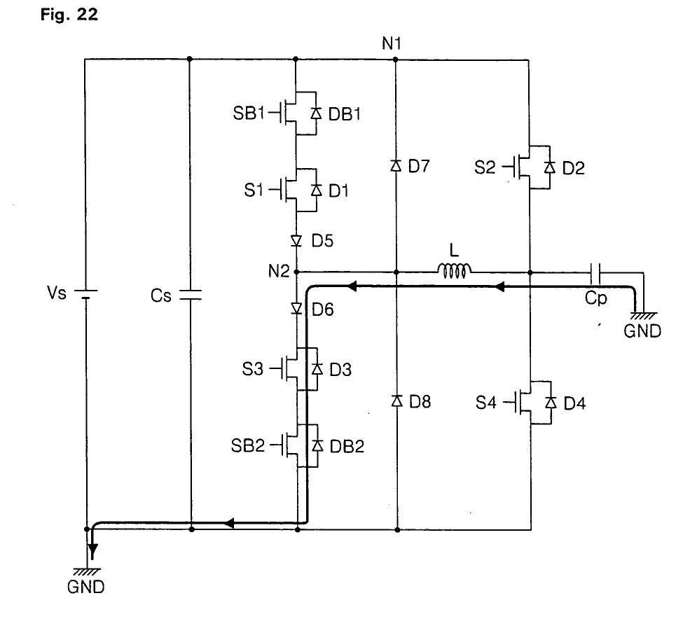

During a period T3, the second switch S2 is turned off. The third switch S3 and the second auxiliary switch SB2 are turned on to discharge the voltage of the panel capacitor Cp to the ground voltage GND during a section-a and are then turned off during a section-b. Once the third switch S3 and the second auxiliary switch SB2 are turned on, the voltage charged within the panel capacitor Cp, as shown in FIG. 22, is supplied to the ground voltage source GND via the inductor L. Hence, the inductor L is charged with prescribed energy.

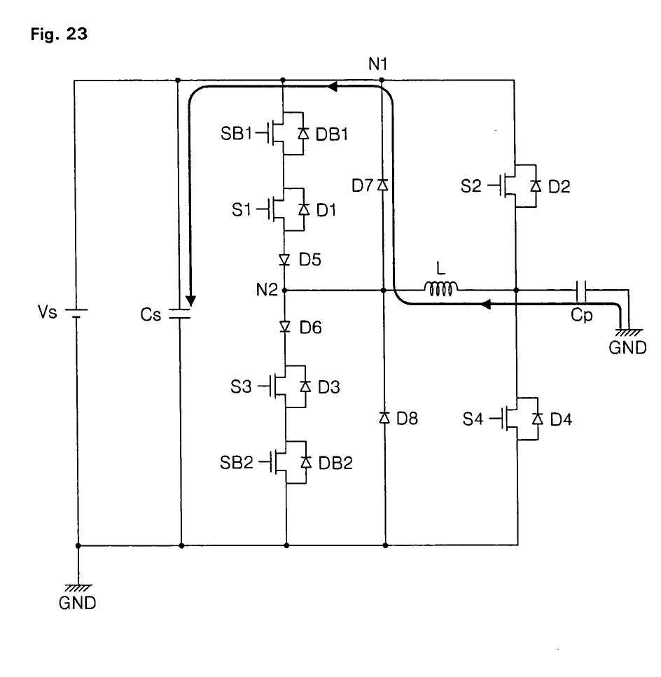

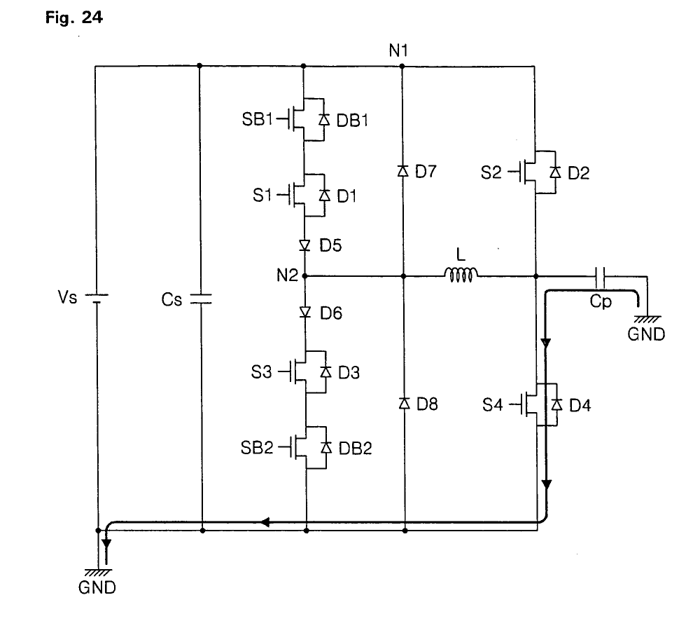

Once the inductor L is sufficiently charged with the energy during the section-a of the period T3, the third switch S3 and the second auxiliary switch SB2 are turned off like the section-b of the period T3, whereby the energy stored in the inductor L, as shown in FIG. 23, is recovered to the source capacitor Cs via the seventh diode D7.

As the voltage of the panel capacitor Cp is supplied to the ground voltage source GND via the inductor L during the period T3, the voltage of the panel capacitor Cp, as shown in FIG. 10, descends in the form of a sine wave. In other words, the voltage of the panel capacitor Cp fails to descend abruptly during the period T3 but gradually descends in the form of a sine curve of which slope at a descending start or end point decreases. Thus, if the potential of the panel capacitor Cp descends like a since curve, electromagnetic interference (EMI) can be reduced.

In the section-a of the period T3, the first switch S1 becomes instantly shorted by the noise. In this case, the noise is induced in a manner that a voltage Vgs between gate and source terminals increases via a parasitic capacitor Cgs between the gate and source terminals when the variance (dv/dt) of the voltage supplied to the second node N2 becomes negative (−) by the current flow of the inductor L. Hence, the first auxiliary switch SB1 prevents the voltage, which is supplied via the first switch S1 shorted at the unwanted time point, from being supplied to the first node N1, thereby enabling to prevent the loss of the voltage supplied to the ground voltage source GND from the panel capacitor Cp.

During a period T4, the third switch S3 and the second auxiliary switch SB2 are turned off the moment the fourth switch S4 is turned on. If the fourth switch S4 is turned on, the panel capacitor Cp, as shown in FIG. 14, is connected to the ground voltage source GND to be supplied with the ground voltage GND. Namely, the panel capacitor Cp maintains at the ground potential GND during the period T4. Substantially, the energy recovery apparatus according to the third embodiment of the present invention periodically repeats the periods T1 to T4 to supply the sustain pulses to the panel capacitor Cp.

### Fourth Embodiment

According to a fourth embodiment of the present invention, an energy recovery apparatus of a plasma display panel includes a first path connected to a panel to supply a voltage higher than a sustain voltage, a second path connected to the first path to clip a voltage on the first path into the sustain voltage if the voltage on the first path reaches the sustain voltage, a third path storing the sustain voltage supplied to the panel in a first source capacitor, a first cut-off element cutting off the voltage supplied to the panel via the first path from being supplied to the third path, and a second cut-off element cutting off a voltage discharged from the panel via the third path from being supplied to the first path.

The energy recovery apparatus further includes a panel capacitor equivalently provided to a discharge cell arranged like a matrix form on the panel, a sustain voltage source generating a voltage lower than the sustain voltage, and a second source capacitor connected parallel to the sustain voltage source to be connected to the first source capacitor.

The first path includes an inductor connected between a second node connected to the second source capacitor and the panel capacitor and a first switch connected between the second node and the inductor to form a path between the second node and the inductor.

The second path includes a second switch connected between a node between the inductor and the panel capacitor and the second node and a first diode connected between a third node between the inductor and the first switch and the ground voltage source.

The first diode prevents a voltage on the third node from decreasing below a ground voltage.

The second switch includes a second diode clipping the voltage on the first path into the sustain voltage.

The third path includes a third switch connected between the third node and the first source capacitor.

The first cut-off element is a first auxiliary switch connected between the first switch and the second node.

The second cut-off element is a second auxiliary switch connected between the third switch and the first source capacitor.

The energy recovery apparatus further includes a fourth path supplying a ground voltage from the ground voltage source to the panel.

The fourth path includes a fourth switch connected between a node between the panel capacitor and the inductor and the ground voltage source.

The energy recovery apparatus further includes a third diode preventing a reverse current between the first switch and the third node, a fourth diode preventing the reverse current between the third node and the third switch, and a fifth diode connected between the third node and the second node to prevent a voltage on the third node from increasing above the sustain voltage.

According to a fourth embodiment of the present invention, an energy recovery method for a plasma display panel includes the steps of forming a first path connected to a panel to supply a voltage higher than a sustain voltage, clipping a voltage on the first path into the sustain voltage by forming a second path connected to the first path if the voltage on the first path reaches the sustain voltage, forming a third path storing the sustain voltage supplied to the panel in a first source capacitor, cutting off the voltage supplied to the panel via the first path from being supplied to the third path, and cutting off a voltage discharged from the panel via the third path from being supplied to the first path.

The energy recovery method further includes a step of maintaining a voltage of a panel capacitor at the sustain voltage wherein the panel capacitor is equivalently provided to a discharge cell arranged like a matrix form on the panel.

In the clipping step, the voltage on the first path is maintained at the sustain voltage in a manner of storing the voltage on the first path in a second source capacitor connected to the first source capacitor using a diode connected to a node between an inductor on the first path and a panel capacitor when the voltage on the first path reaches the sustain voltage.

The step of forming the third path includes a step of storing the voltage charged within the panel capacitor in the first source capacitor via the inductor to decrease the voltage charged within the panel capacitor sinusoidally.

Hereinafter, the fourth embodiment of the present invention will be described in detail with reference to the drawings.

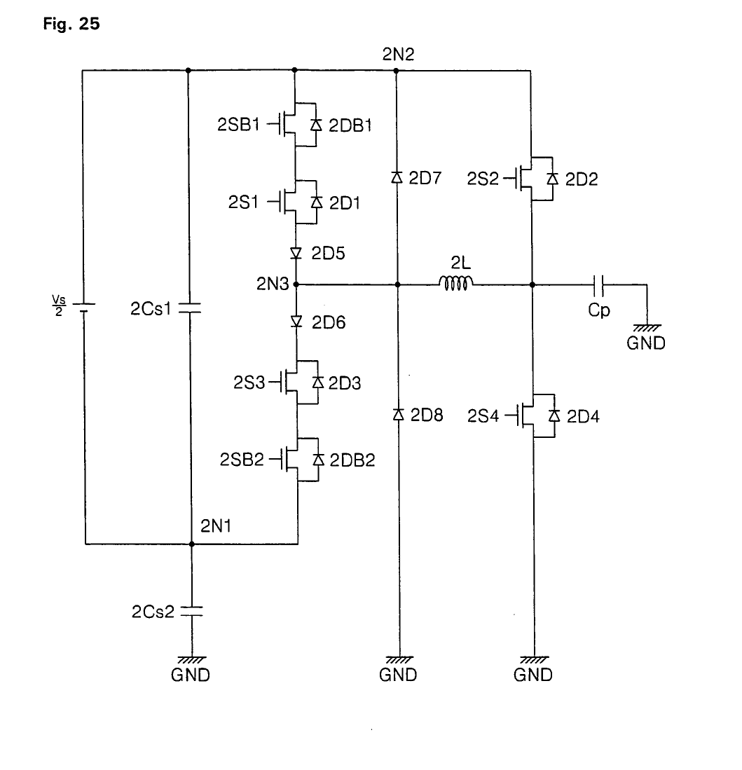

FIG. 25 is a circuit diagram of an energy recovery apparatus of a plasma display panel according to a fourth embodiment of the present invention. In FIG. 25, an energy recovery apparatus provided to one side of a panel capacitor Cp, e.g., next to a scan electrode Y, is shown. Substantially, a like energy recovery apparatus is provided to the other side of the panel capacitor Cp.

Referring to FIG. 25, an energy recovery apparatus according to a fourth embodiment of the present invention includes a panel capacitor Cp equivalently provided to a discharge cell, a reference voltage source Vs/2 having a voltage amounting to a half of sustain voltage Vs, first and second source capacitors 2Cs1 and 2Cs2 connected parallel to the reference voltage source Vs/2, first and third switches 2S1 and 2S3 connected parallel between a second node 2N2 connected to the reference voltage source Vs/2 and a first node 2N1 between the first and second source capacitors 2Cs1 and 2Cs2, an inductor 2L connected between the panel capacitor Cp and a third node 2N3 between the first and third switches 2S1 and 2S3, and second and fourth switches 2S2 and 2S4 connected parallel between the panel capacitor Cp and the inductor 2L.

The first and second switches 2S1 and 2S2 are connected to the reference voltage source Vs/2, and the fourth switch 2S4 is connected to a ground voltage source GND. And, the third switch 2S3 is connected to the first node 2N1 to which the reference voltage source Vs/2 and the first and second source capacitors 2Cs1 and 2Cs2 are connected. The first and second source capacitors 2Cs1 and 2Cs2 recover to be charged with the voltage charged within the panel capacitor Cp on sustain discharge and then re-supply the charged voltage to the panel capacitor Cp. In doing so, each of the first and second source capacitors 2Cs1 and 2Cs2 is charged with the voltage of Vs/2 amounting to a half value of the sustain voltage source Vs. The inductor 2L constructs a resonance circuit together with the panel capacitor Cp. Each of the first to fourth switches 2S1 to 2S4 is turned on or off to form a current path so that the sustain voltage Vs can be supplied to the panel capacitor Cp. Moreover, internal diodes 2D1 to 2D4 are provided to the first to fourth switches 2S1 to 2S4, respectively to control a current flow.

Meanwhile, the energy recover apparatus for a plasma display panel according to the fourth embodiment of the present invention further includes a first auxiliary switch 2SB1 provided between the first switch 2S1 and the first source capacitor 2Cs1, a second auxiliary switch 2SB2 provided between the third switch 2S3 and the first node 2N1, a fifth diode 2D5 provided between the inductor 2L and the first switch 2S1, a sixth diode 2D6 provided between the inductor 2L and the third switch 2S3, a seventh diode 2D7 provided between a second node 2N2 and a third node 2N3, and an eighth diode 2D8 provided between the third node 2N3 and the ground voltage source GND.

During a slope-increasing section P1 and slope-decreasing section P2 of the sustain voltage Vs supplied to the panel capacitor Cp, an abrupt flow of the current flowing through the inductor 2L, as shown in FIG. 17, increases a variance (dv/dt) of a voltage VL at the third node 2N3 connected to the first terminal of the inductor 2L, thereby bringing about noise. By the noise, the first or third switch 2S1 or 2S3 is instantly shorted at an unwanted time point. Yet, the first and second auxiliary switches 2SB1 and 2SB2 enable to prevent the voltage losses caused by the instant short-circuit of the first and third switches 2S1 and 2S3 at the unwanted time points, respectively. Moreover, internal diodes 2DB1 and 2DB2 are provided to the first and second auxiliary switches 2SB1 and 2SB2, respectively to control a current flow.

Specifically, the first switch 2S1 becomes shorted by a parasitic capacitor Cgs between the gate and source terminals when the noise generated from the variance (dv/dt) of the voltage supplied to the third node 2N3 by the current flow of the inductor 2L is negative (−). Hence, the first auxiliary switch 2SB1 prevents the voltage, which is supplied via the first switch 2S1 shorted at the unwanted time point, from being supplied to the second node 2N2.

Likewise, the third switch 2S3 becomes shorted by a parasitic capacitor Cgd between the gate and source terminals when the noise generated from the variance (dv/dt) of the voltage supplied to the third node 2N3 by the current flow of the inductor 2L is positive (+). Hence, the second auxiliary switch 2SB2 prevents the voltage, which is supplied via the third switch 2S3 shorted at the unwanted time point, from being supplied to the first node 2N1.

Thus, the first and second auxiliary switches 2SB1 and 2SB2 enable to prevent the voltage losses caused by the instant short-circuit, which is triggered by the noise due to the variance (dv/dt) of the voltage supplied to the third node 2N3 according to the direction of the current flowing through the inductor 2L, of the first and third switches 2S1 and 2S3 at the unwanted time points, respectively.

The fifth and sixth diodes 2D5 and 2D6 prevent a reverse current from flowing. The seventh diode 2D7 prevents the voltage between the inductor 2L and the fifth diode 2D5, i.e., the voltage at the third node 2N3, from exceeding the sustain voltage Vs. And, the eighth diode 2D8 prevents the voltage between the inductor 2L and the sixth diode 2D6, i.e., the voltage at the third node 2N3, from decreasing below the ground potential GND.

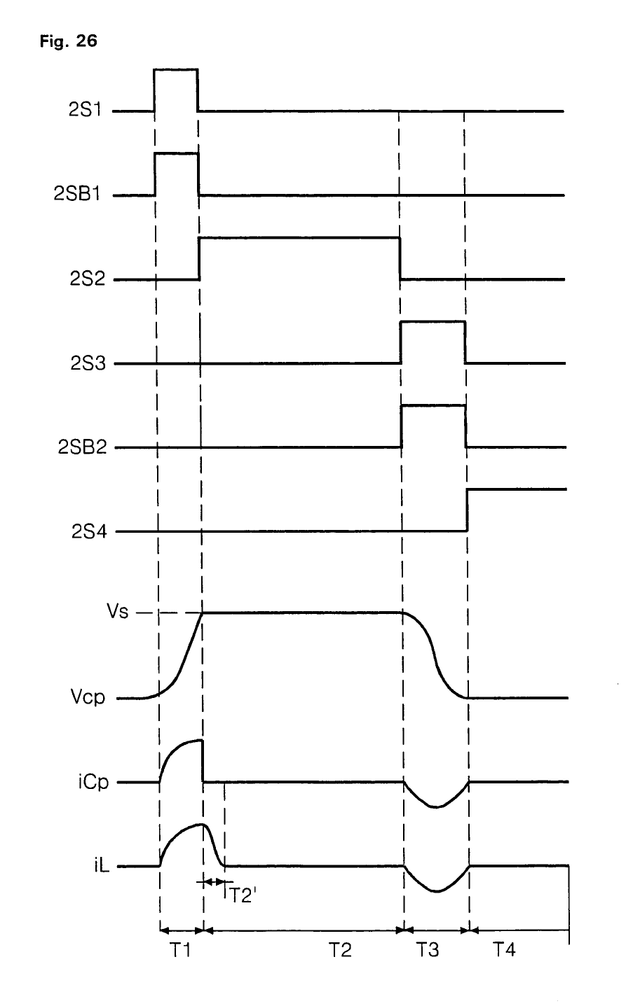

FIG. 26 is a waveform diagram of on/off timings of switches of the energy recovery apparatus of a plasma display panel shown in FIG. 25.

By combining FIG. 26 and FIG. 25, an energy recovery apparatus of a plasma display panel and method thereof according to a fourth embodiment of the present invention are explained in the following. First of all, assuming that the panel capacitor Cp, first source capacitor 2Cs1, and second source capacitor 2Cs2 are charged with 0V, Vs/2, and Vs/2 prior to a period T1, respectively, an operational process is explained in detail as follows. Namely, each voltage of the first and second source capacitors 2Cs1 and 2Cs2 becomes Vs/2 by repeating charging/discharging during periods T1 to T4.

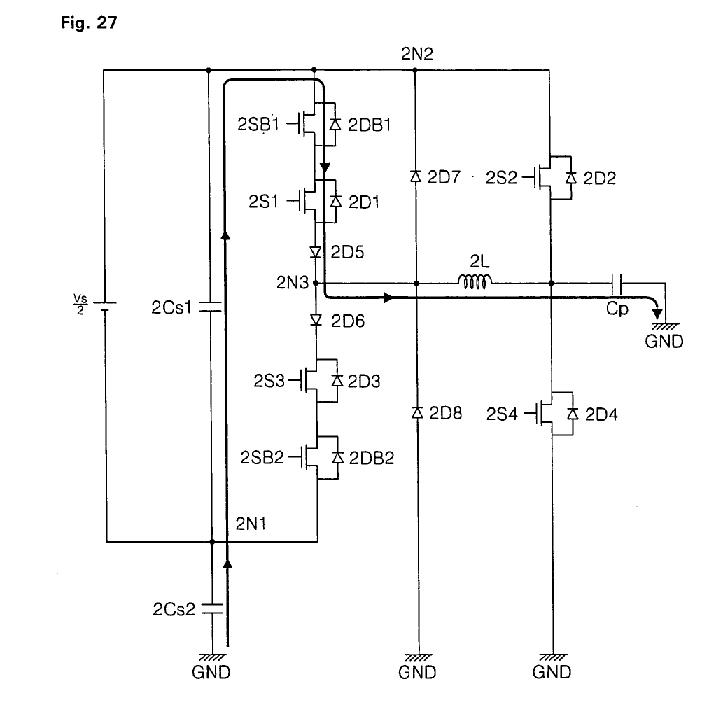

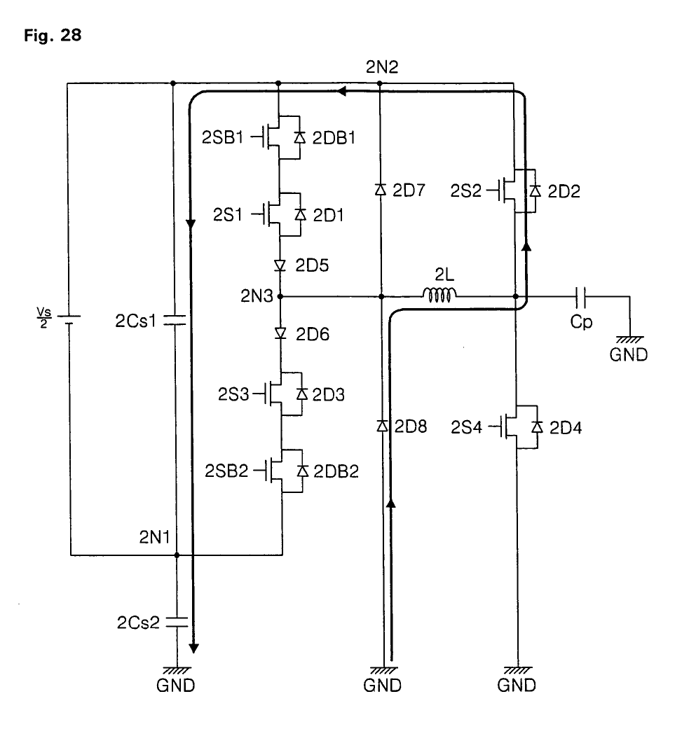

During a period T1, the first switch 2S1 and first auxiliary switch 2SB1 are turned on. Once the first switch 2S1 and auxiliary switch 2SB1 are turned on, the sustain voltage Vs applied to the second node 2N2 from the first and second source capacitors 2Cs1 and 2Cs2, as shown in FIG. 27, is passed through the first auxiliary switch 2SB1, first switch 2S1, and inductor 2L to be supplied to the panel capacitor Cp. In doing so, the inductor 2L is charged with prescribed energy. In this case, the inductor 2L constructs a serial resonance circuit together with the panel capacitor Cp. Hence, the voltage applied to the panel capacitor Cp can be raised to a voltage of 2Vs as indicated by a dotted line in FIG. 20. Yet, the voltage substantially applied to the panel capacitor Cp is limited to the sustain voltage Vs by the internal diode 2D2 of the second switch 2S2. (In this case, a time point of turning off the first switch 2S1 and the first auxiliary switch 2SB1 can be set to a time point that the panel capacitor Cp is charged with a specific voltage.) In other words, the voltage supplied to the panel capacitor Cp is clipped by the internal diode 2D2 of the second switch 2S2 not to exceed the sustain voltage Vs.

And, the third switch 2S3 becomes instantly shorted by the noise. In this case, the noise is induced in a manner that a voltage Vgs between gate and source terminals increases via a parasitic capacitor Cgd between the gate and source terminals when the variance (dv/dt) of the voltage supplied to the third node 2N3 becomes positive (+) by the current flowing through the inductor 2L during the period T1. Hence, the second auxiliary switch 2SB2 prevents the voltage, which is supplied via the third switch 2S3 shorted at the unwanted time point, from being supplied to the ground voltage source GND, thereby enabling to prevent the loss of the voltage supplied to the panel capacitor Cp from the first and second source capacitors 2Cs1 and 2Cs2.

Accordingly, the voltage supplied to the panel capacitor Cp during the period T1 is abruptly raised by resonance with an abrupt slope until reaching the sustain voltage Vs (i.e., the slope never decreases right before the voltage reaches the sustain voltage Vs). Hence, the present invention enables to bring about sustain discharge stably.

During a period T2, the first switch 2S1 and the first auxiliary switch 2SB1 are turned off but the second switch 2S2 is turned on. When the second switch 2S2 is turned on, the voltage of the panel capacitor Cp is maintained at the sustain voltage Vs. Meanwhile, if the first switch 2S1 and the first auxiliary switch 2SB1 are turned off, the polarity of the energy charged within the inductor 2L during the period T1 becomes reversed. In other words, if the first switch 2S1 and the first auxiliary switch 2SB1 are turned off, a reverse voltage, as shown in FIG. 18, is induced on the inductor 2L so that the voltage at the third node 2N3 abruptly decreases to the negative voltage (−) or ground potential GND during a period T2 shown in FIG. 26 to turn on an electric current through the eighth diode D8. Hence, the reverse voltage (reverse energy) induced on the inductor 2L is passed through a current path including the eighth diode D8, the inductor 2L, and the internal diode 2D2 of the second switch 2S2 to be recovered to the first source capacitor 2Cs1. In doing so, the first source capacitor 2Cs1 recovers to store the sustain voltage Vs˜2Vs generated from LC resonance.

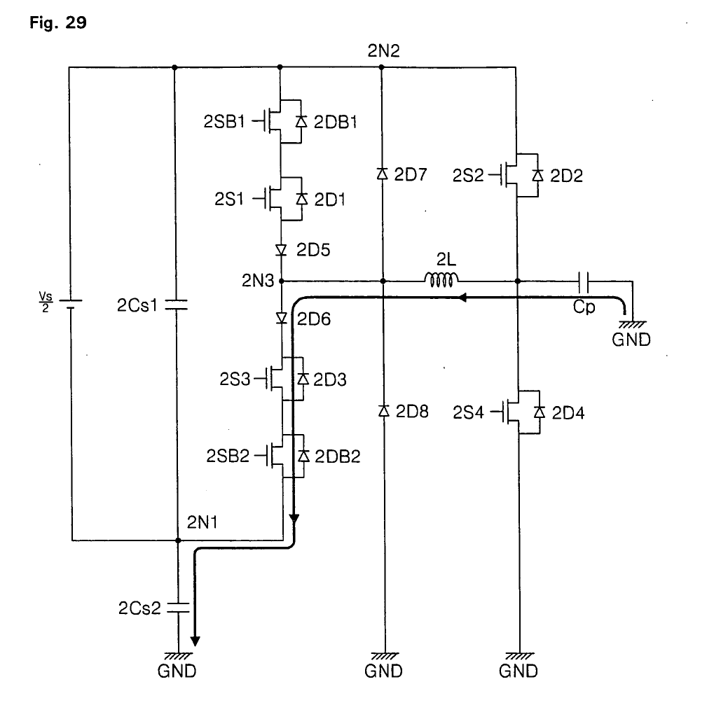

During a period T3, the second switch 2S2 is turned off the moment the third switch S3 and the second auxiliary switch SB2 are turned on. Once the third switch S3 and the second auxiliary switch SB2 are turned on, the remaining voltage charged within the panel capacitor Cp, as shown in FIG. 29, is recovered to the second source capacitor 2Cs2 via the inductor 2L, sixth diode 2D6, third switch 2S3, and second auxiliary switch 2SB2. In doing so, the inductor 2L is charged with prescribed energy. In this case, as the voltage of the panel capacitor Cp is supplied to the second source capacitor 2Cs2 via the inductor 2L, the voltage of the panel capacitor Cp, as shown in FIG. 10, descends in the form of a sine wave. In other words, the voltage of the panel capacitor Cp fails to descend abruptly during the period T3 but gradually descends in the form of a sine curve of which slope at a descending start or end point decreases. Thus, if the potential of the panel capacitor Cp descends like a since curve, electromagnetic interference (EMI) can be reduced.

In the period T3, the first switch 2S1 becomes instantly shorted by the noise. In this case, the noise is induced in a manner that a voltage Vgs between gate and source terminals increases via a parasitic capacitor Cgs between the gate and source terminals when the variance (dv/dt) of the voltage supplied to the third node 2N3 becomes negative (−) by the current flow of the inductor 2L. Hence, the first auxiliary switch 2SB1 prevents the voltage, which is supplied via the first switch 2S1 shorted at the unwanted time point, from being supplied to the second node 2N2, thereby enabling to prevent the loss of the voltage recovered to the second source capacitor 2Cs2 from the panel capacitor Cp.

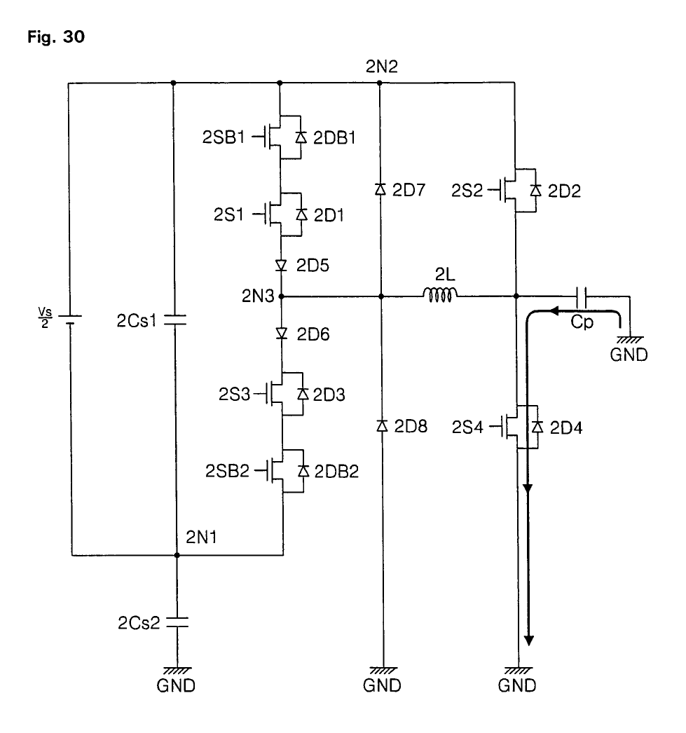

During a period T4, the third switch 2S3 and the second auxiliary switch 2SB2 are turned off the moment the fourth switch 2S4 is turned on. If the fourth switch 2S4 is turned on, the panel capacitor Cp, as shown in FIG. 30, is connected to the ground voltage source GND to be supplied with the ground voltage GND. Namely, the panel capacitor Cp maintains at the ground potential GND during the period T4. Substantially, the energy recovery apparatus according to the fourth embodiment of the present invention periodically repeats the periods T1 to T4 to supply the sustain pulses to the panel capacitor Cp.

As mentioned in the foregoing description, in an energy recovery apparatus of a plasma display panel and method thereof according to the third or fourth embodiments of the present invention, the resonance circuit is configured to generate the voltage higher than that to be supplied to the panel capacitor and the specific one of the generated voltage is controlled to be supplied to the panel capacitor only. Hence, the present invention enables to trigger stable sustain discharge. In other words, since the voltage supplied to the panel capacitor increases with the abrupt slope, the sustain discharge can occur regardless of the amount of charged particles included within the panel capacitor. And, since the voltage charged within the panel capacitor is discharged via the inductor, the voltage of the panel capacitor descends in the form of the since wave. Therefore, EMI can be minimized.

Moreover, the present invention configures the cut-off circuit, which prevents the sustain voltage from being supplied to either the ground voltage source or the sustain voltage source by the noise, thereby enabling to prevent the sustain voltage loss caused by the noise.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An energy recovery apparatus of a plasma display panel, comprising:
a resonance circuit making a sustain voltage resonate to generate a voltage increasing to a double voltage of the sustain voltage;
a diode limiting the voltage generated from the resonance circuit not to exceed the sustain voltage; and
a panel supplied with the sustain voltage from the resonance circuit under a control of the diode.

2. The energy recovery apparatus of claim 1, further comprising:
a source capacitor connected to the resonance circuit to store the sustain voltage therein; and
a sustain voltage source connected parallel to the source capacitor.

3. The energy recovery apparatus of claim 2, the resonance circuit comprising:
a panel capacitor equivalently provided to a discharge cell arranged like a matrix form on the panel; and
an inductor connected between the panel capacitor and the source capacitor.

4. The energy recovery apparatus of claim 3, the energy recovery apparatus further comprising:
a first switch provided between the source capacitor and one side of the inductor to be turned on if the charged sustain voltage of the source capacitor is supplied to the inductor;
a second switch provided between the source capacitor and the other side of the inductor to be turned on if the sustain voltage is supplied to the panel;
a third switch provided between a ground voltage source and the one side of the inductor to be turned on if the voltage charged within the panel is discharged; and
a fourth switch provided between the ground voltage source and the other side of the inductor to be turned on if a voltage of the ground voltage source is supplied to the panel.

5. The energy recovery apparatus of claim 4, wherein the diode is an internal diode of the second switch.

6. The energy recovery apparatus of claim 4, wherein if the first switch is turned on, the inductor is charged with energy and wherein if the first switch is turned off, the charged energy of the inductor is supplied to the source capacitor via at least one of the diode and the second switch.

7. The energy recovery apparatus of claim 4, wherein if the third switch is turned on, the voltage charged within the panel sinusoidally descends via the inductor to be supplied to the ground voltage source.

8. The energy recovery apparatus of claim 7, wherein the energy charged within the inductor via the turned-on third switch is supplied to the source capacitor via an internal diode of the first switch after the third switch is turned off.

9. The energy recovery apparatus of claim 1, further comprising:
a reference voltage source connected to the resonance circuit to have a voltage value corresponding to a half of the sustain voltage; and
a source capacitor provided between the reference voltage source and a ground voltage source to be charged with a voltage corresponding to the half of the sustain voltage.

10. The energy recovery apparatus of claim 9, the resonance circuit comprising:
a panel capacitor equivalently provided to a discharge cell arranged like a matrix form on the panel; and
an inductor connected between the panel capacitor and a common terminal between the source capacitor and the reference voltage source.

11. The energy recovery apparatus of claim 10, wherein the sustain voltage generated from adding the voltage value of the reference voltage source to the voltage of the source capacitor is supplied to the resonance circuit.

12. The energy recovery apparatus of claim 10, the energy recovery apparatus further comprising:
a first switch provided between the reference voltage source and one side of the inductor to be turned on if the sustain voltage is supplied to the inductor;
a second switch provided between the reference voltage source and the other side of the inductor to be turned on if the sustain voltage is supplied to the panel;
a third switch provided between the source capacitor and the one side of the inductor to be turned on if the voltage charged within the panel is recovered to the source capacitor; and
a fourth switch provided between the ground voltage source and the other side of the inductor to be turned on if a voltage of the ground voltage source is supplied to the panel.

13. The energy recovery apparatus of claim 12, wherein the diode is an internal diode of the second switch.

14. The energy recovery apparatus of claim 12, wherein if the third switch is turned on, the voltage charged within the panel sinusoidally descends via the inductor to be supplied to the source capacitor.

15. The energy recovery apparatus of claim 12, the energy recovery apparatus further comprising:
a first diode provided between the first switch and the inductor to prevent a reverse current;
a second diode provided between the second switch and the inductor to prevent the reverse current;
a third diode provided between the ground voltage source and a common terminal of the first diode, the second diode, and the inductor to maintain a voltage of the common terminal of the first diode, the second diode, and the inductor above the voltage of the ground voltage source; and
a fourth diode provided between the common terminal of the first diode, the second diode, and the inductor and the reference voltage source to maintain the voltage of the common terminal of the first diode, the second diode, and the inductor below the sustain voltage.

16. An energy recovery method of a plasma display panel, comprising:
a first step of making a sustain voltage resonate to generate a voltage increasing to a double voltage of the sustain voltage; and
a second step of supplying the voltage generated from the first step to a panel capacitor equivalently provided to a discharge cell by controlling the voltage generated from the first step not to exceed the sustain voltage.

17. The energy recovery method of claim 16, further comprising:
a third step of maintaining a voltage of the panel capacitor at the sustain voltage; and
a fourth step of discharging the voltage charged within the panel capacitor via an inductor so that the voltage charged within the panel capacitor can descend sinusoidally.

18. The energy recovery method of claim 16, wherein in the second step, the voltage generated in the first step is controlled not to exceed the sustain voltage using a diode provided between a resonance circuit generating a voltage increasing to a double voltage of the sustain voltage and a sustain voltage source.

19. An energy recovery apparatus of a plasma display panel which supplies a positive first voltage and a negative second voltage to generate sustain discharge, wherein
the energy recovery apparatus includes a resonance circuit making the first voltage resonate to generate a voltage increasing to a double voltage of the first voltage, a diode limiting the voltage generated from the resonance circuit not to exceed the first voltage, and a panel supplied with the first voltage from the resonance circuit under a control of the diode to increase a voltage of the panel to the first voltage from the second voltage.

20. The energy recovery apparatus of claim 19, wherein the energy recovery apparatus further includes a reference voltage source having a negative terminal connected to a ground voltage source to supply the first voltage to the resonance circuit and a source capacitor having a positive terminal connected to the negative terminal of the reference voltage source to generate the second voltage by recovering to be charged with the first voltage charged within the panel.

21. The energy recovery apparatus of claim 20, wherein the first and second voltages are set equal to each other in an absolute voltage value.

22. The energy recovery apparatus of claim 20, wherein the resonance circuit includes a panel capacitor equivalently provided to a discharge cell arranged like a matrix form on the panel and an inductor connected between the panel capacitor and the reference voltage source.

23. The energy recovery apparatus of claim 22, wherein the energy recovery apparatus further includes a first switch provided between the reference voltage source and one side of the inductor to be turned on if the first voltage is supplied to the inductor, a second switch provided between the reference voltage source and the other side of the inductor to be turned on if the first voltage is supplied to the panel, a third switch provided between the positive terminal of the source capacitor and the one side of the inductor to be turned on if the voltage charged within the panel is supplied to the source capacitor, and a fourth switch provided between the negative terminal of the source capacitor and the other side of the inductor to be turned on if the second voltage is supplied to the panel.

24. The energy recovery apparatus of claim 23, wherein the diode is an internal diode of the second switch.

25. The energy recovery apparatus of claim 23, wherein if the third switch is turned on, the voltage charged within the panel sinusoidally descends via the inductor to be supplied to the source capacitor.

26. The energy recovery apparatus of claim 23, wherein the energy recovery apparatus further includes a first diode provided between the first switch and the inductor to prevent a reverse current, a second diode provided between the second switch and the inductor to prevent the reverse current, a third diode provided between a common terminal of the first switch and the first diode and the negative terminal of the source capacitor to prevent a voltage of the common terminal of the first switch and the first diode from decreasing below the second voltage, and a fourth diode provided between a common terminal of the inductor and the first diode and the reference voltage source to prevent a voltage of the common terminal of the inductor and the first diode from increasing above the first voltage.

27. An energy recovery method of a plasma display panel which supplies a positive first voltage and a negative second voltage to generate sustain discharge, wherein
the energy recovery method includes the steps of making the first voltage resonate to generate a voltage increasing to a double voltage of the first voltage, controlling the resonating voltage not to exceed the first voltage, and supplying the resonating voltage to a panel to increase a voltage of the panel to the first voltage from the second voltage.

28. The energy recovery method of claim 27, wherein the energy recovery method further includes the steps of maintaining the first voltage after the voltage of the panel is increased to the first voltage and decreasing the voltage of the panel to the second voltage via an inductor to enable the voltage of the panel decrease sinusoidally.

29. The energy recovery method of claim 27, wherein the first and second voltages are set equal to each other in an absolute voltage value.

30. An energy recovery apparatus of a plasma display panel, comprising:
a first path connected to a panel to supply a voltage higher than a sustain voltage;
a second path connected to the first path to clip a voltage on the first path into the sustain voltage if the voltage on the first path reaches the sustain voltage;
a third path discharging the sustain voltage supplied to the panel to a ground voltage source;
a first cut-off element cutting off the voltage supplied to the panel via the first path from being supplied to the third path; and
a second cut-off element cutting off the voltage discharged from the panel via the third path from being supplied to the first path.

31. The energy recovery apparatus of claim 30, further comprising:
a panel capacitor equivalently provided to a discharge cell arranged like a matrix form on the panel;
a sustain voltage source generating the sustain voltage; and
a source capacitor supplied with the sustain voltage from the sustain voltage source, the source capacitor storing the voltage supplied via the second path.

32. The energy recovery apparatus of claim 31, the first path comprising:
a first node connected to the source capacitor;
an inductor connected between the first node and the panel capacitor; and
a first switch connected between the first node and the inductor to form a path between the source capacitor and the inductor.

33. The energy recovery apparatus of claim 32, the second path comprising:
a second switch connected between the first node and a node between the inductor and the panel capacitor; and
a first diode connected between a second node between the inductor and the first switch and the ground voltage source.

34. The energy recovery apparatus of claim 33, wherein the first diode prevents a voltage on the second node from decreasing below a ground voltage.

35. The energy recovery apparatus of claim 33, wherein the second switch comprises a second diode clipping a voltage on the first path into the sustain voltage.

36. The energy recovery apparatus of claim 33, wherein the third path comprises a third switch connected between the second node and the ground voltage source.

37. The energy recovery apparatus of claim 32, wherein the first cut-off element is a first auxiliary switch connected between the first switch and the first node.

38. The energy recovery apparatus of claim 36, wherein the second cut-off element is a second auxiliary switch connected between the third switch and the ground voltage source.

39. The energy recovery apparatus of claim 32, wherein the energy recovery apparatus further comprises a fourth path supplying a ground voltage from the ground voltage source to the panel.

40. The energy recovery apparatus of claim 39, wherein the fourth path comprises a fourth switch connected between a node between the panel capacitor and the inductor and the ground voltage source.

41. The energy recovery apparatus of claim 36, the energy recovery apparatus further comprising:
a third diode preventing a reverse current between the first switch and the second node;
a fourth diode preventing the reverse current between the second node and the third switch; and
a fifth diode connected between the second node and the first node to prevent a voltage on the second node from increasing above the sustain voltage.

42. An energy recovery method of a plasma display panel, comprising the steps of:
forming a first path connected to a panel to supply a voltage higher than a sustain voltage;
clipping a voltage on the first path into the sustain voltage by forming a second path connected to the first path if the voltage on the first path reaches the sustain voltage;
forming a third path discharging the sustain voltage supplied to the panel to a ground voltage source;
cutting off the voltage supplied to the panel via the first path from being supplied to the third path; and
cutting off the voltage discharged from the panel via the third path from being supplied to the first path.

43. The energy recovery method of claim 42, further comprising a step of maintaining a voltage of a panel capacitor at the sustain voltage wherein the panel capacitor is equivalently provided to a discharge cell arranged like a matrix form on the panel.

44. The energy recovery method of claim 42, wherein in the clipping step, the voltage on the first path is maintained at the sustain voltage in a manner of storing the voltage on the first path in a source capacitor using a diode connected to a node between an inductor on the first path and a panel capacitor when the voltage on the first path reaches the sustain voltage.

45. The energy recovery method of claim 44, wherein in the step of forming the third path, the voltage charged within the panel capacitor is discharged to the ground voltage source via the inductor to decrease the voltage charged within the panel capacitor sinusoidally.

46. An energy recovery apparatus of a plasma display panel, comprising:
a first path connected to a panel to supply a voltage higher than a sustain voltage;
a second path connected to the first path to clip a voltage on the first path into the sustain voltage if the voltage on the first path reaches the sustain voltage;
a third path storing the sustain voltage supplied to the panel in a first source capacitor;
a first cut-off element cutting off the voltage supplied to the panel via the first path from being supplied to the third path; and
a second cut-off element cutting off a voltage discharged from the panel via the third path from being supplied to the first path.

47. The energy recovery apparatus of claim 46, further comprising:
a panel capacitor equivalently provided to a discharge cell arranged like a matrix form on the panel;
a sustain voltage source generating a voltage lower than the sustain voltage; and
a second source capacitor connected parallel to the sustain voltage source to be connected to the first source capacitor.

48. The energy recovery apparatus of claim 47, the first path comprising:
an inductor connected between a second node connected to the second source capacitor and the panel capacitor; and
a first switch connected between the second node and the inductor to form a path between the second node and the inductor.

49. The energy recovery apparatus of claim 48, the second path comprising:
a second switch connected between a node between the inductor and the panel capacitor and the second node; and
a first diode connected between a third node between the inductor and the first switch and the ground voltage source.

50. The energy recovery apparatus of claim 49, wherein the first diode prevents a voltage on the third node from decreasing below a ground voltage.

51. The energy recovery apparatus of claim 49, wherein the second switch comprises a second diode clipping the voltage on the first path into the sustain voltage.

52. The energy recovery apparatus of claim 48, wherein the third path comprises a third switch connected between the third node and the first source capacitor.

53. The energy recovery apparatus of claim 48, wherein the first cut-off element is a first auxiliary switch connected between the first switch and the second node.

54. The energy recovery apparatus of claim 52, wherein the second cut-off element is a second auxiliary switch connected between the third switch and the first source capacitor.

55. The energy recovery apparatus of claim 48, wherein the energy recovery apparatus further comprises a fourth path supplying a ground voltage from the ground voltage source to the panel.

56. The energy recovery apparatus of claim 55, wherein the fourth path comprises a fourth switch connected between a node between the panel capacitor and the inductor and the ground voltage source.

57. The energy recovery apparatus of claim 52, the energy recovery apparatus further comprising:
a third diode preventing a reverse current between the first switch and the third node;
a fourth diode preventing the reverse current between the third node and the third switch; and
a fifth diode connected between the third node and the second node to prevent a voltage on the third node from increasing above the sustain voltage.

58. An energy recovery method for a plasma display panel, comprising the steps of:
forming a first path connected to a panel to supply a voltage higher than a sustain voltage;
clipping a voltage on the first path into the sustain voltage by forming a second path connected to the first path if the voltage on the first path reaches the sustain voltage;
forming a third path storing the sustain voltage supplied to the panel in a first source capacitor;
cutting off the voltage supplied to the panel via the first path from being supplied to the third path; and
cutting off a voltage discharged from the panel via the third path from being supplied to the first path.

59. The energy recovery method of claim 58, further comprising a step of maintaining a voltage of a panel capacitor at the sustain voltage wherein the panel capacitor is equivalently provided to a discharge cell arranged like a matrix form on the panel.

60. The energy recovery method of claim 58, wherein in the clipping step, the voltage on the first path is maintained at the sustain voltage in a manner of storing the voltage on the first path in a second source capacitor connected to the first source capacitor using a diode connected to a node between an inductor on the first path and a panel capacitor when the voltage on the first path reaches the sustain voltage.

61. The energy recovery method of claim 60, wherein the step of forming the third path comprises a step of storing the voltage charged within the panel capacitor in the first source capacitor via the inductor to decrease the voltage charged within the panel capacitor sinusoidally.
